(19) United States
(12) Patent Application Publication
(10) Pub. No.: US 2007/0112078 A1
(43) Pub. Date: May 17, 2007

(54) Silicone antifoam composition

(76) Inventors: Ian Procter, Bogis-Bossey (CH); Kalman Koczo, Suffern, NY (US); David George Quinn, Prangins (CH); Daniel Yves Sane, Geneve (CH)

Correspondence Address: DILWORTH & BARRESE, LLP, 333 EARLE OVINGTON BLVD., SUITE 702, UNIONDALE, NY, 11553, US

(21) Appl. No.: 11/274,832

(22) Filed: Nov. 15, 2005

(51) Int. Cl. C09K 3/00

(52) U.S. Cl. 516/117

(57) ABSTRACT

There is provided antifoam composition comprising an antifoaming-effective amount of at least one antifoam component, where antifoam component comprises product of the reaction of (a) at least one silicone fluid, (b) at least one silicone resin selected from the group consisting of silicone resin (i) having a ratio of M to Q units of from about 0.6/1 to about 0.8/1 and a different silicone resin (ii) having a ratio of M to Q units of from about 0.55/1 to about 0.75/1, optionally, (c) at least one inorganic particulate possessing reactive surface groups; and, optionally, (d) catalyst for the reaction of (a) and/or (b) with (c).

### BACKGROUND OF THE INVENTION

(1) Field of the Invention

The invention herein is directed towards silicone anti-foam composition.

(2) Description of the Prior Art

The foaming of liquid occurs in a number of processes in various types of industries. Sometimes such foam is desirable; in other cases the foam is undesirable. Accordingly, in many industries during the processing of material undesirable foam is formed in some part(s) of the process. Foam is formed when the rate of decay of foam is slower than the creation of new foam bubbles. Accordingly, when you have such a condition in a chemical or mechanical process there results the creation of ever-increasing foam that is so stabilized that it does not decay very rapidly. Accordingly, in such cases, it is desirable to utilize some means to remove the undesirable foam. It is desirable to remove or reduce the foaming in many processes, since the unwanted foam can create a hazard, such as a fire hazard or as is well realized, the foam takes up a considerable amount of space thus requiring more space in which to carry out the process. Foam can make the process difficult to operate and thus less efficient. Accordingly, in such processes in which undesirable foam is formed, it is highly desirable to have some means of reducing or completely removing the foam. Although there are many ways of defoaming a process, the most desirable is the chemical means since this usually is the most efficient way to remove the foam.

It is known that the problem of foaming can be solved by an antifoam sometimes also called: defoamer having the effect of breaking foam in a liquid or reducing its foamability. A silicone antifoam is particularly suitable, since it is chemically stable and hardly has an influence on the liquid to which it is applied, and its use in a very small quantity produces a relatively large antifoaming effect. Unfortunately, silicone antifoams still poses problems for various industries in terms of cost and efficiency of the antifoam. Many industries would find it desirable to use smaller amounts of the silicone antifoam to destabilize foam. There is also a differentiated need among the various users for antifoams with either good initial effect (knockdown) or long time persistence (durability), or both.

### BRIEF DESCRIPTION OF THE INVENTION

In this brief description it is noted that the present inventors have unexpectedly discovered, in one specific embodiment, antifoam composition. In one embodiment, this antifoam composition comprises at least one unique antifoam component where antifoam component contains the product of the reaction of silicone fluid, silicone resin, optionally, inorganic particulate and optionally, catalyst.

Thus, in one specific embodiment there is provided antifoam composition comprising an antifoaming-effective amount of at least one antifoam component, where antifoam component comprises product of the reaction of

(a) at least one silicone fluid, (b) at least one silicone resin selected from the group consisting of silicone resin (i) having a ratio of M to Q units of from about 0.6/1 to about 0.8/1 and a different silicone resin (ii) having a ratio of M to Q units of from about 0.55/1 to about 0.75/1,

(c) at least one inorganic particulate possessing reactive surface groups; and,

optionally, (d) catalyst for the reaction of (a) and/or (b) with (c).

### DETAILED DESCRIPTION OF THE INVENTION

In one embodiment, as used herein knockdown characterizes the initial efficiency of an antifoam and the knockdown can be measured through various known test methods. In one specific embodiment, in a “recirculation test”, as described below, the knockdown level is the lowest level a foam collapses to from a pretreated height after that foam is treated with an antifoaming-effective amount of antifoam composition. In a “shake test”, as described below, knockdown is measured as the time it takes for a foam to collapse following a short period of shaking. In one specific embodiment herein a short period of shaking is specifically of from about 5 to about 60 seconds.

In yet another embodiment, antifoam durability characterizes the persistence of an antifoam during continuous foam generation. It can be measured through similar test methods to knockdown as described above. In a “recirculation test”, as described below, durability level is the amount of time in seconds that a foaming process that has been treated with antifoam composition will take to regenerate foam to the predetermined height at which it was treated or some other pre-determined height. In the “shake test” described below, durability time is measured as the time it takes for a foam to collapse following a long period of shaking or for a sequence for multiple shakes. In one specific embodiment herein, a long period of shaking is specifically of from about 10 to about 60 minutes.

In another embodiment, as used herein an antifoaming-effective amount is the parts per million (ppm) of antifoam composition used to treat a foaming process that will cause a complete collapse of the foam after a period of shaking. In one other specific embodiment herein said antifoaming-effective amount is of from about 1 to about 1000 ppm.

It will be understood herein that the terms polyorganosiloxane and organopolysiloxane are interchangeable.

It will be understood herein that all uses of the term centistokes were measured at 25 degrees celsius.

It will also be understood herein that all specific, more specific and most specific ranges encompass all sub-ranges there between.

It will be understood herein that knockdown time and durability time as described herein are measured using a version of the “Defoaming activity” test of Simethicone Emulsion, as described in US Pharmacopoeia #23, p. 1410-1411 that has been modified referred to herein as the “modified shake test” and is described herein.

Antifoam component contains at least one silicone fluid (a), which can be any commercially available or industrially used silicone fluid. In one embodiment, silicone fluid (a) is polyorganosiloxane. In one specific embodiment silicone fluid (a) is polyorganosiloxane having a viscosity specifically of from about 1000 to about 10,000,000 centistokes, more specifically of from about 5000 to about 2,000,000 centistokes and most specifically, of from about 10,000 to about 1,000,000 centistokes.

In one specific embodiment, silicone fluid (a) can comprise two silicone fluids, which can be blended together to achieve the above noted viscosities for silicone fluid (a). In a further specific embodiment antifoam composition can comprise at least two antifoam components which are reacted separately and wherein an at least one first silicone fluid (a) in a first antifoam component has a lower viscosity than an at least one second silicone fluid (a) in a second antifoam component. In yet a further embodiment, first silicone fluid and/or second silicone fluid can independently be a blend of two or more silicone fluids (a) which are blended together to achieve the above noted viscosities for silicone fluid (a), provided that first silicone fluid has a lower blended viscosity than second silicone fluid. In one specific embodiment silicone fluid (a) or first and/or second silicone fluid as described above can be silicone equilibrate, stripped silicone equilibrate, or a blend of different silicones. In a more specific embodiment, silicone fluid (a) or first and/or second silicone fluid as described above can have reactive groups that have the potential to react under the conditions used to prepare antifoam composition herein, resulting in an increase in polyorganosiloxane polymer molecular weight.

In a more specific embodiment, first silicone fluid (a) is a first polyorganosiloxane having a viscosity of from about 1000 to about 100,000 centistokes and second silicone fluid is a second polyorganosiloxane having a viscosity of from about 10,000 to about 10,000,000 centistokes, the viscosity of the second silicone fluid being greater than the viscosity of first silicone fluid. In an even more specific embodiment first silicone fluid is a first polyorganosiloxane having a viscosity of from about 5000 to about 90,000 centistokes and second silicone fluid is a second polyorganosiloxane having a viscosity of from about 30,000 to about 2,000,000 centistokes, the viscosity of second silicone fluid being greater than the viscosity of first silicone fluid. In yet an even more specific embodiment, first silicone fluid is a first polyorganosiloxane having a viscosity of from about 10,000 to about 80,000 centistokes and second silicone fluid is a second polyorganosiloxane having a viscosity of from about 60,000 to about 1,000,000 centistokes, the viscosity of the second silicone fluid being greater than the viscosity of first silicone fluid.

In another specific embodiment herein, the organo groups of polyorganosiloxane (a) can be any organo group commonly associated with such polymers and can generally be selected from the non-limiting examples of alkyl radicals of 1 to about 8 carbon atoms, such as methyl, ethyl, propyl; cycloalkyl radicals such as cyclohexyl, cycloheptyl, cyclooctyl; mononuclear aryl radicals such as phenyl, methylphenyl, ethylphenyl; alkenyl radicals such as vinyl and allyl; and haloalkyl radicals such as 3,3,3, trifluoropropyl. In a more specific embodiment, the organo groups are alkyl radicals of 1 to 8 carbon atoms, and are most specifically methyl. In one specific embodiment herein, polyorganosiloxane can be trimethyl or silanol endblocked polyorganosiloxane.

In one embodiment herein, at least one silicone fluid (a) is polyorganosiloxane having the formula:
MₐD_{b}M*₂₋ₐ
where
D=R¹R²SiO_{2/2}
M=R³R⁴R⁵SiO_{1/2}
M*=R^{α}R^{β}R^{γ}SiO_{1/2}
where R¹, R², R³, R⁴, R⁵, R^{β} and R^{γ} are independently monovalent hydrocarbon radicals having one to sixty carbon atoms; R^{α} is a hydrocarbon radical having from one to sixty carbon atoms and containing either at least one hydroxyl group or at least one alkoxy group; the stoichiometric subscripts a and b are either zero or positive; subject to the limitations: b is a number greater than 220, and a is a number of from 0 to about 2. In another specific embodiment herein first silicone fluid and/or second silicone fluid can have the same formula as defined above for silicone fluid (a).

In one specific embodiment herein polyorganosiloxanes having the formula MₐD_{b}M*₂₋ₐ are very well known in the silicone art and can be produced by various well known methods. In one specific embodiment herein the above described at least one silicone fluid (a) can further comprise where M* is as described above and is a dimethyl silanol or dimethyl alkoxy endblocking group.

In one specific embodiment silicone fluid (a) can be an organomodified silicone fluid such as aminosilicone. In a further embodiment, some specific non-limiting examples of aminosilicones have the formula MₐDₓD*_{y}M*₂₋ₐ, where D, M and M*have the same definitions as provided above for formula MₐD_{b}M*₂₋ₐ, D*=R^{A}SiO_{2/2}(CH₂)₃NH(CH₂)₂NH₂; where x is from 0 to 1000, y is from 0.5 to 25, a is a number of from 0 to 2 and where R^{A} is a monovalent hydrocarbon radical having from 1 to about sixty carbon atoms. In one specific embodiment R^{A} is specifically methyl or phenyl.

In one further specific embodiment first silicone fluid and/or second silicone fluid can be an organomodified silicone fluid such as aminosilicone, with the same specific non-limiting examples of aminosilicones as described above for silicone fluid (a).

In a further specific embodiment, antifoam component also contains at least one silicone resin (b) containing at least one M unit and at least one Q unit where M is defined as above for formula M^{a}D^{b}M*₂₋ₐ and Q=SiO_{4/2}. In one embodiment, silicone resin (b) can be any commercially available or industrially used silicone resin. In one specific embodiment at least one silicone resin (b) is selected from the group consisting of silicone resin (i) having a ratio of M to Q units of from about 0.6/1 to about 0.8/1 and a different silicone resin (ii) having a ratio of M to Q units of from about 0.55/1 to about 0.75/1. In an even more specific embodiment, silicone resin (i) has a ratio of M to Q units of from about 0.63/1 to about 0.73/1 and silicone resin (ii) has a ratio of M to Q units of from about 0.57/1 to about 0.70/1. In a yet even more specific embodiment, silicone resin (i) has a ratio of M to Q units of from about 0.65/1 to about 0.70/1 and silicone resin (ii) has a ratio of M to Q units of from about 0.60/1 to about 0.67/1.

In a further specific embodiment, as described above, antifoam composition can comprise at least two antifoam components which are reacted separately and further, where silicone resin (i) in a first antifoam component is different from silicone resin (ii) in a second antifoam component. In yet a further embodiment, silicone resin (i) and/or silicone resin (ii) can independently be a blend of two or more silicone resins (b), provided that silicone resin (i) is different from silicone resin (ii). In one specific embodiment, silicone resin (i) and different silicone resin (ii) can be a silicone resin that is supplied as a 100 weight percent resin, or as a certain weight percent of resin in a volatile solvent, or as a resin solution within silicone fluid (a) or first silicone fluid and/or second silicone fluid as described above; and if silicone resin is supplied in solvent, the majority of the solvent is removed during preparation of antifoam composition. In one specific embodiment herein, some non-limiting examples of solvent are hexanes, xylenes, toluene, aromatic solvents, volatile silicones and combinations thereof. In one embodiment herein silicone resin (i) and/or silicone resin (ii) can be supplied in polyorganosiloxane fluid, such as the non-limiting example of polydimethylsiloxane fluid. In a further specific embodiment silicone resin (i) and/or silicone resin (ii) that can be supplied in polyorganosiloxane fluid that has a viscosity of from about 10 to about 10,000 centistokes, more specifically 15 to about 9,000 centistokes and most specifically 25 to about 5000 centistokes.

In one embodiment herein, silicone resin (i) and silicone resin (ii) is selected from the group consisting of

M_{c}M^{H}_{d}M^{vi}ₑM^{E}_{f}Q_{g}T^{OH}ₐₐ;

MₕM^{H}ᵢM^{vi}ⱼM^{E}ₖD_{L}D^{H}ₘD^{vi}ₙD^{E}ₒQₚT^{OH}_{bb};

T_{q}T^{H}ᵣT^{vi}ₛT^{E}ₜD^{OH}_{cc} resin and combinations thereof

where

M=R⁶R⁷R⁸SiO_{1/2};

M^{H}=R⁹R¹⁰HSiO_{1/2};

M^{vi}=R¹¹R¹²R¹³SiO_{1/2};

M^{E}=R¹⁴R¹⁵R^{E}SiO_{1/2};

D=R¹⁶R¹⁷SiO_{2/2};

D^{H}=R¹⁸HSiO_{2/2};

D^{vi}=R¹⁹R²⁰SiO_{2/2};

D^{E}=R²¹R^{E}SiO_{2/2};

D^{OH}=R^{BB}R^{CC}SiO_{2/2}

T=R²²SiO_{3/2};

T^{H}=HSiO_{3/2};

T^{vi}=R²³SiO_{3/2};

T^{E}=R^{E}SiO_{3/2};

T^{OH}═R^{AA}SiO_{3/2}

Q=SiO_{4/2}; and,

where R^{AA} and R^{BB} are independently OH or OR^{DD}, where R^{DD} is a monovalent hydrocarbon radical containing from one to six carbon atoms, R^{CC} is independently R²², hydrogen, R²³ or R^{E}; further where R⁶, R⁷, R⁸, R¹⁶, R¹⁷, and R²² are independently monovalent hydrocarbon radicals containing from one to sixty carbon atoms; R⁹, R¹⁰ and R¹⁸ are independently monovalent hydrocarbon radicals containing from one to sixty carbon atoms or hydrogen; R¹¹ is an unsaturated monovalent hydrocarbon radical containing from 2 to 10 carbon atoms, and R¹² and R¹³ are independently monovalent hydrocarbon radicals containing from one to sixty carbon atoms; R¹⁹ is an unsaturated monovalent hydrocarbon radical containing from 2 to 10 carbon atoms, and R²⁰ is a monovalent hydrocarbon radical containing from one to sixty carbon atoms; R²³ is an unsaturated monovalent hydrocarbon radical containing from 2 to 10 carbon atoms; R¹⁴, R¹⁵ and R²¹ are independently monovalent hydrocarbon radicals having from one to sixty carbons or R^{E}; each R^{E} is independently a monovalent hydrocarbon radical containing one or more oxirane moieties having from one to sixty carbon atoms; the stoichiometric subscripts c, d, e, f, g, h, i, j, k, L, m, n, o, p, q, r, s, t, aa, bb, and cc are zero or positive subject to the following limitations: if M_{c}M^{H}_{d}M^{vi}ₑM^{E}_{f}Q_{g}T^{OH}ₐₐ resin is used c+d+e+f≧3, g+aa≧2; and c+d+e+f+g≧5; if MₕM^{H}ᵢM^{E}ₖD_{L}D^{H}ₘD^{vi}ₙD^{E}ₒQₚT^{OH}_{bb} resin is used h+i+j+k≧3, L+m+n+o≧1, p+bb≧2, and h+i+j+k+L+m+n+o+p≧6; and if T_{q}T^{H}ᵣT^{vi}ₛT^{E}ₜD^{OH}_{cc} resin is used q+r+s+t+cc≧2.

In another specific embodiment when M_{c}M^{H}_{d}M^{vi}ₑM^{E}_{f}Q_{g}T^{OH}ₐₐ resin is used as described above M_{c}M^{H}_{d}M^{vi}ₑM^{E}_{f}Q_{g}T^{OH}ₐₐ resin can further comprise where c+d+e+f≧4, g+aa≧8; and c+d+e+f+g+aa≧12. In yet another specific embodiment when MₕM^{H}ᵢM^{vi}ⱼM^{E}ₖD_{L}D^{H}ₘD^{vi}D^{E}ₒQₚT^{OH}_{bb} resin is used as described above MₕM^{H}ᵢM^{vi}ⱼM^{E}ₖD_{L}D^{H}ₘD^{vi}ₙD^{E}ₒQₚT^{OH}_{bb} resin can further comprise where h+i+j+k≧4, L+m+n+o≧1, p+bb≧8, and h+i+j+k+L+m+n+o+p+bb≧13.

In one specific embodiment herein, at least one silicone resin is selected from the group consisting of silicone resin (i) being M_{c}M^{H}_{d}M^{vi}ₑM^{E}_{f}Q_{g}T^{OH}ₐₐ resin and having a ratio of (M+M^{H}+M^{vi}+M^{E}) to (Q+T^{OH}ₐₐ) of from 0.6/1 to about 0.8/1 and different silicone resin (ii) being M_{c}M^{H}_{d}M^{vi}ₑM^{E}_{f}Q_{g}T^{OH}ₐₐ resin and having a ratio of (M+M^{H}+M^{vi}+M^{E}) to (Q+T^{OH}ₐₐ) of from about 0.55/1 to about 0.75/1.

In another specific embodiment herein, at least one silicone resin is selected from the group consisting of silicone resin (i) being M_{c}M^{H}_{d}M^{vi}ₑM^{E}_{f}Q_{g}T^{OH}ₐₐ resin and having a ratio of (M+M^{H}+M^{vi}+M^{E}) to (Q+T^{OH}) of from 0.63/1 to about 0.73/1 and different silicone resin (ii) being M_{c}M^{H}_{d}M^{vi}ₑM^{E}_{f}Q_{g}T^{OH}ₐₐ resin and having a ratio of (M+M^{H}+M^{vi}+M^{E}) to (Q+T^{OH}) of from about 0.57/1 to bout 0.70/1.

In yet another specific embodiment herein, at least one silicone resin is selected from the group consisting of silicone resin (i) being M_{c}M^{H}_{d}M^{vi}ₑM^{E}_{f}Q_{g}T^{OH}ₐₐ resin and having a ratio of (M+M^{H}+M^{vi}+M^{E}) to (Q+T^{OH}) of from 0.65/1 to about 0.70/1 and different silicone resin (ii) being M_{c}M^{H}_{d}M^{vi}ₑM^{E}_{f}Q_{g}T^{OH}ₐₐ resin and having a ratio of (M+M^{H}+M^{vi}+M^{E}) to (Q+T H) of from about 0.60/1 to about 0.67/1.

In another specific embodiment herein, at least one silicone resin is selected from the group consisting of silicone resin (i) being M_{c}M^{H}_{d}M^{vi}ₑM^{E}_{f}Q_{g}T^{OH}ₐₐ resin and having a (M+M^{H}+M^{vi}+M^{E}) to (Q+T^{OH}) ratio of from about 0.6 to about 0.8, and different silicone resin (ii) being M_{c}M^{H}_{d}M^{vi}ₑM^{E}_{f}Q_{g}T^{OH}ₐₐ resin and having a (M+M^{H}+M^{vi}+M^{E}) to (Q+T^{OH}) ratio of from about 0.55 to about 0.75, and silicone fluid (a) is polyorganosiloxane having a viscosity of from about 1000 to about 10,000,000 centistokes.

In another specific embodiment herein, silicone resin (i) is M_{c}M^{H}_{d}M^{vi}ₑM^{E}_{f}Q_{g}T^{OH}ₐₐ resin having a (M+M^{H}+M^{vi}+M^{E}) to (Q+T^{OH}) ratio of from about 0.6 to about 0.8, and different silicone resin (ii) is M_{c}M^{H}_{d}M^{vi}ₑM^{E}_{f}Q_{g}T^{OH}ₐₐ resin having a (M+M^{H}+M^{vi}+M^{E}) to (Q+T^{OH}) ratio of from about 0.55 to about 0.75, first silicone fluid is a first polyorganosiloxane having a viscosity of from about 1000 to about 100,000 centistokes and second silicone fluid is a second polyorganosiloxane having a viscosity of from about 10,000 to about 10,000,000 centistokes, the viscosity of second silicone fluid being greater than the viscosity of first silicone fluid.

In one specific embodiment herein, at least one silicone resin is selected from the group consisting of silicone resin (i) being MₕM^{H}ᵢM^{vi}ⱼM^{E}ₖD_{L}D^{H}ₘD^{vi}ₙD^{E}ₒQₚT^{OH}_{bb} resin and having a ratio of (M+M^{H}+M^{vi}+M^{E}) to (Q+T H) of from 0.6/1 to about 0.8/1 and different silicone resin (ii) being MₕM^{H}ᵢM^{vi}ⱼM^{E}ₖD_{L}D^{H}ₘD^{vi}ₙD^{E}ₒQₚT^{OH}_{bb} resin and having a ratio of (M+M^{H}+M^{vi}+M^{E}) to (Q+T^{OH}) of from about 0.55/1 to about 0.75/1.

In another specific embodiment herein, at least one silicone resin is selected from the group consisting of silicone resin (i) being MₕM^{H}ᵢM^{vi}ⱼM^{E}ₖD^{L}D^{H}ₘD^{vi}ₙD^{E}ₒQₚT^{OH}_{bb} resin and having a ratio of (M+M^{H}+M^{vi}+M^{E}) to (Q+T^{OH}) of from 0.63/1 to about 0.73/1 and different silicone resin (ii) being MₕM^{H}ᵢM^{vi}ⱼM^{E}ₖD^{L}D^{H}ₘD^{vi}ₙD^{E}ₒQₚT^{OH}_{bb} resin and having a ratio of (M+M^{H}+M^{vi}+M^{E}) to (Q+T^{OH}) of from about 0.57/1 to about 0.70/1.

In yet another specific embodiment herein, at least one silicone resin is selected from the group consisting of silicone resin (i) being MₕM^{H}ᵢM^{vi}ⱼM^{E}ₖD_{L}D^{H}ₘD^{vi}ₙD^{E}ₒQₚT^{OH}_{bb} resin and having a ratio of (M+M^{H}+M^{vi}+M^{E}) to (Q+T H) of from 0.65/1 to about 0.70/1 and different silicone resin (ii) being MₕM^{H}ᵢM^{vi}ⱼM^{E}ₖD_{L}D^{H}ₘD^{vi}ₙD^{E}ₒQₚT^{OH}_{bb} resin and having a ratio of (M+M^{H}+M^{vi}+M^{E}) to (Q+T H) of from about 0.60/1 to about 0.67/1.

In another specific embodiment herein, at least one silicone resin is selected from the group consisting of silicone resin (i) being MₕM^{H}ᵢM^{vi}ⱼM^{E}ₖD_{L}D^{H}ₘD^{vi}ₙD^{E}ₒQₚT^{OH}_{bb} resin and having a (M+M^{H}+M^{vi}+M^{E}) to (Q+T^{OH}) ratio of from about 0.6 to about 0.8, and different silicone resin (ii) being MₕM^{H}ᵢM^{vi}ⱼM^{E}ₖD_{L}D^{H}ₘD^{vi}ₙD^{E}ₒQₚT^{OH}_{bb} resin and having a (M+M^{H}+M^{vi}+M^{E}) to (Q+T^{OH}) ratio of from about 0.55 to about 0.75, and silicone fluid (a) is polyorganosiloxane having a viscosity of from about 1000 to about 10,000,000 centistokes.

In another specific embodiment herein, silicone resin (i) is MₕM^{H}ᵢM^{vi}ⱼM^{E}ₖD_{L}D^{H}ₘD^{vi}ₙD^{E}ₒQₚT^{OH}_{bb} resin having a (M+M^{H}+M^{vi}+M^{E}) to (Q+T^{OH}) ratio of from about 0.6 to about 0.8, and different silicone resin (ii) is MₕM^{H}ᵢM^{vi}ⱼM^{E}ₖD_{L}D^{H}ₘD^{vi}ₙD^{E}ₒQₚT^{OH}_{bb} resin having a (M+M^{H}+M^{vi}+M^{E}) to (Q+T^{OH}) ratio of from about 0.55 to about 0.75, first silicone fluid is a first polyorganosiloxane having a viscosity of from about 1000 to about 100,000 centistokes and second silicone fluid is a second polyorganosiloxane having a viscosity of from about 10,000 to about 10,000,000 centistokes, the viscosity of second silicone fluid being greater than the viscosity of first silicone fluid.

It will be understood herein, that in one specific embodiment, silicone resin (i) and/or different silicone resin (ii) is selected from the group consisting of M_{c}M^{H}_{d}M^{vi}ₑM^{E}_{f}Q_{g}T^{OH}ₐₐ, MₕM^{H}ᵢM^{vi}ⱼM^{E}ₖD_{L}D^{H}ₘD^{vi}ₙD^{E}ₒQₚT^{OH}_{bb} and T_{q}T^{H}ᵣT^{vi}ₛT^{E}ₜD^{OH}_{cc} silicone resin(s) and combinations thereof which can be used with the proviso that silicone resin (i) has a (M+M^{H}+M^{vi}+M^{E}) to (Q+T^{OH}) ratio of about 0.6 to about 0.8 and different silicone resin (ii) has a different (M+M^{H}+M^{vi}+M^{E}) to (Q+T^{OH}) ratio of from about 0.55 to about 0.75, with the further proviso that silicone resin (i) and different silicone resin (ii) each independently must contain at least one silicone resin of the above described general formulas M_{c}M^{H}_{d}M^{vi}ₑM^{E}_{f}Q_{g}T^{OH}ₐₐ or MₕM^{H}ᵢM^{vi}ⱼM^{E}ₖD_{L}D^{H}ₘD^{vi}ₙD^{E}ₒQₚT^{OH}_{bb}.

In one specific embodiment herein, more than one silicone resin (i) and/or more than one different silicone resin (ii) can be used which are selected from the group consisting of M_{c}M^{H}_{d}M^{vi}ₑM^{E}_{f}Q_{g}T^{OH}ₐₐ, MₕM^{H}ᵢM^{vi}ⱼM^{E}ₖD_{L}D^{H}ₘD^{vi}ₙD^{E}ₒQₚT^{OH}_{bb} and T_{q}T^{H}ᵣT^{vi}ₛT^{E}ₜD^{OH}_{cc} and combinations thereof with the proviso that at least one silicone resin (i) has a (M+M^{H}+M^{vi}+M^{E}) to (Q+T H) ratio of about 0.6 to about 0.8 and at least one different silicone resin (ii) has a different (M+M^{H}+M^{vi}+M^{E}) to (Q+T^{OH}) ratio of from about 0.55 to about 0.75, with the further proviso that at least one silicone resin (i) and at least one different silicone resin (ii) each independently must contain at least one silicone resin of the above described general formulas M_{c}M^{H}_{d}M^{vi}ₑM^{E}_{f}Q_{g}T^{OH}ₐₐ, or MₕM^{H}ⱼM^{vi}ⱼM^{E}ₖD_{L}D^{H}ₘD^{vi}ₙD^{E}ₒQₚT^{OH}_{bb}.

In one specific embodiment, at least one antifoam component can comprise at least one inorganic particulate (c) possessing reactive surface groups. In a further specific embodiment inorganic particulate (c) possessing reactive surface groups comprises fumed silica and optionally another inorganic particulate (c) such as the non-limiting examples selected from the group consisting of precipitated silica, silica aerogel, silica gel, hydrophobic silica, hydrophilic silica, silica that has been treated with a silicone material, silica that has been treated with a silane material, silica that has been treated with a nitrogen-containing material, titania, alumina, quartz, a different fumed silica and combinations thereof. In a further specific embodiment, as described above, antifoam composition can comprise at least two antifoam components which are reacted separately; and further, where an at least one first inorganic particulate is present in a first antifoam component and an at least one second inorganic particulate is optionally present in a second antifoam component, wherein first and second inorganic particulate are each at least one inorganic particulate (c). In one specific embodiment herein, at least one inorganic particulate (c) can be silica that has been treated with a silicon-based material to make it hydrophobic. In one other embodiment herein inorganic particulate (c) can be a combination of silicas.

In a further specific embodiment, inorganic particulate (c), can be any amorphous silica, and desirably contains surface hydroxyl groups, provided that inorganic particulate (c) comprises fumed silica as described above. In one specific embodiment, specific amorphous silica(s) that can be utilized are those non-limiting examples that are commercially available from Degussa under the name of Aerosil® or Sipemat®. In one specific embodiment herein, silica is generally identified as silicon dioxide having a specific surface area of from about 50 to about 500 square meters per gram (m²/g), more specifically of from about 60 to about 450 m²/g and most specifically of from about 80 to about 400 m²/g and these ranges of surface area can apply to any inorganic particulate (c) described herein. In one specific embodiment herein inorganic particulate (c) can comprise hydrophobized and/or hydrophilic inorganic particulate (c), provided that inorganic particulate (c) comprises fumed silica as described above. In one further specific embodiment any silica used herein can be hydrophobic and/or hydrophilic silica. In one specific embodiment both hydrophilic and hydrophobic inorganic particulate (c) can comprise hydroxy groups.

In one more specific embodiment, for maximum effectiveness, fumed silica and optionally precipitated silica having a specific surface area of from about 80 to about 400 m²/g can be used herein. In another specific embodiment herein however, inorganic particulate(c), below this level of surface area will also function in a similar manner. In one specific embodiment, inorganic particulate (c) possessing reactive surface groups can be treated with filler treating compound. In one specific embodiment, some non-limiting examples of suitable filler treating compound for inorganic particulate (c) utilized in anti-foam composition herein include the non-limiting examples of silanols, silanes, silazanes, low molecular weight linear polysiloxanes and cyclic polysiloxanes, such as octamethylcyclotetrasiloxane. In another specific embodiment, a further non-limiting example of a suitable silazane is hexamethyldisilazane. In another specific embodiment, a further non-limiting example of a suitable silane is trimethylchlorosilane.

In one further specific embodiment, at least one inorganic particulate (c) when present, can be the same or different inorganic particulate, such as is described above. In one specific embodiment when at least two antifoam components are used as described herein, first antifoam component can have a high level of silica loading, specifically from about 2 to about 10 weight percent, more specifically from about about 2.5 to about 9 weight percent and most specifically from about 3 to about 8 weight percent based on the total weight of first antifoam component; and second antifoam component can have a low level of silica loading, specifically from about 0.2 to about 8 weight percent, more specifically from about 0.35 to about 6 weight percent and most specifically from about 0.5 to about 5 weight percent based on the total weight of second antifoam component, provided that first antifoam component has a higher level of silica loading than second antifoam component. In yet a further specific embodiment first antifoam component and second antifoam component can have equivalent levels of silica loading. In yet still even a further specific embodiment herein it will be understood that any of the above described ranges of silica loading can be used for any one or more of the inorganic particulate (c) as described above or in combination with silica.

In a specific embodiment herein, catalyst (d) can optionally be used for reaction of at least one silicone fluid (a) and/or at least one silicone resin (b) with at least one inorganic particulate (c). In another specific embodiment herein, catalyst can optionally be used for reaction of at least one first silicone fluid and/or at least one silicone resin (i) with at least one first inorganic particulate (c). In another specific embodiment herein catalyst can optionally be used for reaction of at least one second silicone fluid and/or at least one different silicone resin (ii) with at least one optionally present, second inorganic particulate (c), when second inorganic particulate (c) is present. In one specific embodiment, catalyst is strong acid or strong base that is capable of accelerating equilibration or condensation of silicone. In another embodiment catalyst is strong acid or strong base that is capable of accelerating equilibration or condensation of silicone in absence of silica, T or Q units and at reaction conditions used in preparation of antifoam composition herein. In another embodiment herein, catalyst is strong base introduced as 100 percent catalyst or as a solution of catalyst in water and/or alcohol; some non-limiting examples of an alcohol that can be used herein are methanol, ethanol, n-propanol, iso-propanol, butanol and combinations thereof. In one embodiment herein a majority of water or alcohol is removed during preparation of antifoam composition herein.

In one further embodiment herein, catalyst (d) is specifically selected from siloxane equilibration and/or silanol-condensing catalysts such as alkali metal hydroxides, alkali metal silanolates, alkali metal alkoxides, quaternary ammonium hydroxides and silanolates, quaternary phosphonium hydroxides and silanolates and metal salts as well as metal acid salts such as the non-limiting example of FeCl₃. These compounds are well known in the field of silicone chemistry and are not considered to need any detailed description. In one specific non-limiting embodiment, KOH and CsOH are non-limiting examples of alkali metal hydroxides. In a further specific embodiment, if alkali metal hydroxide is reacted with low molecular weight silicone or silicate or a partially hydrolyzed product thereof, there is obtained an alkali metal silanolate. In one other specific embodiment, alkali metal alkoxide is a product of the reaction between an alkali metal hydroxide and an alcohol having one to about five carbon atoms. In another specific embodiment, some non-limiting examples of quaternary ammonium hydroxides are beta-hydroxyethyltrimethyl ammonium hydroxide, benzyltrimethyl ammonium hydroxide and tetramethyl ammonium hydroxide. In another specific embodiment, some non-limiting examples of quaternary phosphonium hydroxides are tetrabutyl phosphonium hydroxide and tetraethylphosphonium hydroxide. In yet a further specific embodiment, some non-limiting examples of the metal salts of organic acids are dibutyltin dilaurate, stannous acetate or octanoate, lead naphthenate, zinc octanoate, iron 2-ethylhexoate and cobalt naphthenate. In one embodiment herein, catalyst (d) can comprise more than one catalyst described herein.

In a further specific embodiment, at least one antifoam component can be present in any weight percent amount provided that weight percent of antifoam component substantially comprises antifoam composition. In yet still a further specific embodiment herein at least one antifoam composition can comprise 100 weight percent of at least one antifoam component based on the total weight of antifoam composition.

In a further specific embodiment, as described above, antifoam composition can comprise at least two antifoam components which are reacted separately; and further, where first or second antifoam component can be present in any weight percent amount provided that the sum of weight percent of first antifoam component and weight percent of second antifoam component substantially comprises antifoam composition.

In a yet further specific embodiment herein, antifoam composition contains from about 0.1 to about 99.9 weight percent of at least one antifoam component, said weight percent being based on total weight of at least one antifoam component.

In a yet further specific embodiment herein, antifoam composition contains from about 1 to about 85 weight percent of at least one antifoam component, said weight percent being based on total weight of at least one antifoam component.

In a yet further specific embodiment herein, antifoam composition contains from about 5 to about 70 weight percent of at least one antifoam component, said weight percent being based on total weight of at least one antifoam component.

In a yet further specific embodiment herein, antifoam composition comprises at least two antifoam components and contains from about 0.1 to about 99.9 weight percent first antifoam component and from about 99.9 to about 0.1 weight percent second antifoam component said weight percents being based on the total weight of at least two antifoam components.

In a yet further specific embodiment herein, antifoam composition comprises at least two antifoam components and contains from about 0.5 to about 85 weight percent first antifoam component and from about 70 to about 0.5 weight percent second antifoam component said weight percents being based on the total weight of at least two antifoam components.

In a yet further specific embodiment herein, antifoam composition comprises at least two antifoam components and contains from about 3 to about 70 weight percent first antifoam component and from about 50 to about 2 weight percent second antifoam component, said weight percents being based on the total weight of at least two antifoam components.

In one specific embodiment herein, knockdown amount can be any weight percent amount as described herein of at least one antifoam component or first antifoam component as described herein and durability amount can be any weight percent amount as described herein of at least one antifoam component or second antifoam component as described herein.

In one specific embodiment herein, at least one antifoam component comprises the reaction product of from about 50 to about 98 weight percent of at least one silicone fluid; of from about 3 to about 35 weight percent of at least one silicone resin selected from the group consisting of silicone resin (i) having a ratio of M to Q units of from about 0.6/1 to about 0.8/1 and a different silicone resin (ii) having a ratio of M to Q units of from about 0.55/1 to about 0.75/1; of from about 0.1 to about 20 weight percent of at least one inorganic particulate possessing reactive surface groups, and optionally of from about 0.01 to about 15 weight percent of catalyst for the reaction of at least one silicone fluid, and at least one silicone resin with at least one inorganic particulate possessing reactive surface groups, wherein said weight percents are based upon the total weight of antifoam component.

In one specific embodiment herein, at least one antifoam component comprises the reaction product of from about 75 to about 95 weight percent of at least one silicone fluid (a); of from about 5 to about 20 weight percent of at least one silicone resin selected from the group consisting of silicone resin (i) having a ratio of M to Q units of from about 0.6/1 to about 0.8/1 and a different silicone resin (ii) having a ratio of M to Q units of from about 0.55/1 to about 0.75/1; of from about 0.1 to about 10 weight percent of at least one inorganic particulate (c) possessing reactive surface groups, and optionally of from about 0.1 to about 10 weight percent of catalyst (d) for the reaction of at least one silicone fluid, and at least one silicone resin with at least one inorganic particulate possessing reactive surface groups, wherein said weight percents are based upon the total weight of antifoam component.

In one specific embodiment herein, at least one antifoam component comprises the reaction product of from about 80 to about 90 weight percent of at least one silicone fluid; of from about 8 to about 15 weight percent of at least one silicone resin selected from the group consisting of silicone resin (i) having a ratio of M to Q units of from about 0.6/1 to about 0.8/1 and a different silicone resin (ii) having a ratio of M to Q units of from about 0.55/1 to about 0.75/1; of from about 0.2 to about 8 weight percent of at least one inorganic particulate possessing reactive surface groups, and optionally of from about 0.2 to about 6 weight percent of catalyst for the reaction of at least one silicone fluid, and at least one silicone resin with at least one inorganic particulate possessing reactive surface groups, wherein said weight percents are based upon the total weight of antifoam component.

In a further specific embodiment, as described above, antifoam composition can comprise at least two antifoam components which are reacted separately; and further, where at least one first antifoam component comprises the reaction product of from about 50 to about 98 weight percent of at least one first silicone fluid; of from about 3 to about 35 weight percent of at least one silicone resin (i); of from about 0.1 to about 20 weight percent of at least one first inorganic particulate possessing reactive surface groups, and optionally of from about 0.01 to about 15 weight percent of catalyst for the reaction of at least one first silicone fluid, and/or at least one silicone resin (i) with at least one first inorganic particulate possessing reactive surface groups, wherein said weight percents are based upon the total weight of first antifoam component.

In a further specific embodiment, as described above, antifoam composition can comprise at least two antifoam components which are reacted separately; and further, where at least one first antifoam component comprises the reaction product of from about 75 to about 95 weight percent of at least one first silicone fluid; of from about 5 to about 20 weight percent of at least one silicone resin (i); of from about 1 to about 10 weight percent of at least one first inorganic particulate possessing reactive surface groups, and optionally of from about 0.1 to about 10 weight percent of catalyst for the reaction of at least one first silicone fluid, and/or at least one silicone resin (i) with at least one first inorganic particulate possessing reactive surface groups, wherein said weight percents are based upon the total weight of first antifoam component.

In a further specific embodiment, as described above, antifoam composition can comprise at least two antifoam components which are reacted separately; and further, where at least one first antifoam component comprises the reaction product of from about 80 to about 90 weight percent of at least one first silicone fluid; of from about 8 to about 15 weight percent of at least one silicone resin (i); of from about 3 to about 8 weight percent of at least one first inorganic particulate possessing reactive surface groups, and optionally of from about 0.2 to about 6 weight percent of catalyst for the reaction of at least one first silicone fluid, and/or at least one silicone resin (i) with at least one first inorganic particulate possessing reactive surface groups, wherein said weight percents are based upon the total weight of first antifoam component.

In a further specific embodiment, as described above, antifoam composition can comprise at least two antifoam components which are reacted separately; and further, where at least one second antifoam component comprises the reaction product of from about 50 to about 98 weight percent of at least one second silicone fluid; of from about 5 to about 35 weight percent of at least one silicone resin (ii); of from about 0.1 to about 20 weight percent of at least one second inorganic particulate possessing reactive surface groups, and optionally of from about 0.01 to about 15 weight percent of catalyst for the reaction of at least one second silicone fluid, and/or at least one silicone resin (ii) with at least one second inorganic particulate possessing reactive surface groups, wherein said weight percents are based upon the total weight of second antifoam component.

In a further specific embodiment, as described above, antifoam composition can comprise at least two antifoam components which are reacted separately; and further, where at least one second antifoam component comprises the reaction product of from about 75 to about 95 weight percent of at least one second silicone fluid; of from about 6 to about 20 weight percent of at least one silicone resin (ii); of from about 0.2 to about 8 weight percent of at least one second inorganic particulate possessing reactive surface groups, and optionally of from about 0.1 to about 10 weight percent of catalyst for the reaction of at least one second silicone fluid, and/or at least one silicone resin (ii) with at least one second inorganic particulate possessing reactive surface groups, wherein said weight percents are based upon the total weight of second antifoam component.

In a further specific embodiment, as described above, antifoam composition can comprise at least two antifoam components which are reacted separately; and further, where at least one second antifoam component comprises the reaction product of from about 85 to about 95 weight percent of at least one second silicone fluid; of from about 8 to about 15 weight percent of at least one silicone resin (ii); of from about 0.5 to about 5 weight percent of at least one second inorganic particulate possessing reactive surface groups, and optionally of from about 0.2 to about 5 weight percent of catalyst for the reaction of at least one second silicone fluid, and/or at least one silicone resin (ii) with at least one second inorganic particulate possessing reactive surface groups, wherein said weight percents are based upon the total weight of second antifoam component.

In one specific embodiment at least one antifoam component or at least two antifoam components as described above can be reacted by a process of mixing at least one silicone fluid (a), at least one silicone resin (b), at least one inorganic particulate (c) possessing reactive surface groups and catalyst (d) for the reaction of at least one silicone fluid (a) and/or at least one silicone resin (b) with at least one inorganic particulate (c) possessing reactive surface groups in one step; which is referred to herein as a “one-pot” procedure. In another embodiment herein as part of the one-pot procedure some or all of the volatile component(s) can be removed.

Alternatively, in another specific embodiment, it is possible to react at least one antifoam component or at least two antifoam components as described above, by a process of combining at least one silicone fluid and at least one silicone resin and remove any volatile components prior to the addition of at least one inorganic particulate possessing reactive surface groups and catalyst for the reaction; which is to be herein referred to as a “staggered one-pot” procedure. In another specific embodiment herein as part of the staggered one-pot procedure not all of the volatile component(s) can be removed. In yet another specific embodiment herein, as part of the staggered one-pot procedure additional silicone fluid (a) and silicone resin (b) can be added together with inorganic particulate (c) and catalyst (d). In yet still another further specific embodiment herein, as part of the staggered one-pot procedure, catalyst (d) can be added before or after removal of the volatile component(s). In yet a still even further specific embodiment staggered one-pot procedure can further generally comprise the following steps of: adding catalyst (d) at any stage prior to the final heating step; adding some or all of the silicone fluid (a); adding some or all of the silicone resin (b); adding any amount Of the catalyst (d), adding specifically either none or all of catalyst (d); heating to remove the volatile component(s); adding any remaining silicone fluid (a); adding any remaining silicone resin (b); adding inorganic particulate (c) completely; adding any remaining catalyst (d); and continuing the reaction as described above.

In a still further specific embodiment, at least one antifoam component or at least two antifoam components as described above, is reacted by a process of combining at least one silicone fluid (a) with at least one silicone resin (b), followed by heating and mixing said at least one silicone fluid (a) and said at least one silicone resin (b) followed by ceasing mixing and allowing the heated and mixed at least one silicone fluid (a) and at least one silicone resin (b) to cool to ambient temperatures, which is then followed by addition of at least one inorganic particulate (c) possessing reactive surface groups and catalyst (d) and optionally adding more of silicone fluid (a) and/or optionally adding more and/or different silicone resin (b) for the reaction of at least one silicone fluid (a) and/or at least one silicone resin (b) with at least one inorganic particulate (c) possessing reactive surface groups, followed by heating and mixing; said process of reacting antifoam component; being referred to herein as a “two-pot” process.

In another specific embodiment, at least two antifoam components can be reacted by at least one of the one-pot, staggered one-pot, or two-pot processes as described above for the reaction of antifoam component (a) with the provisos that at least one second inorganic particulate possessing reactive surface groups can be optionally included in second antifoam component and when second inorganic particulate possessing reactive surface groups is so optionally included, catalyst can also optionally be included for reaction of second silicone fluid and/or silicone resin (ii) with second inorganic particulate.

In one embodiment, the one-pot, staggered one-pot and two-pot processes as described herein can generally be conducted with any known, conventional or desirable processing conditions. In one specific embodiment, the one-pot, staggered one-pot and two-pot process can entail heating under continuous and intensive mixing at specifically of from about 120 to about 250 degrees celsius, and for a period of specifically, of from about 1 to about 120 hours; and inorganic particulate possessing reactive surface groups when present, and catalyst when included herein, can be added under shear conditions to ensure good dispersion. In one specific embodiment herein longer heating time can be used for second antifoam component when at least two antifoam components are used.

In still a further embodiment, mixing as described herein, can be conducted by an appropriate dispersing device such as the non-limiting examples of homo-mixer, colloid mill, laboratory agitator, triple roll mill and combinations thereof.

In one specific embodiment, mixing and heating of at least one antifoam component or at least two antifoam components, as described above, can be conducted in inert gas atmosphere, to avoid any danger and remove volatile matter (unreacted matter, by products). In one embodiment, mixing order, heating temperature and time as herein stated are not critical, but can be changed as required.

In one specific embodiment herein, first and second antifoam components, as described above, can be heated and reacted separately and then combined to form antifoam composition.

In one embodiment, antifoam composition produced herein can be used as antifoam composition directly in the treatment of a surfactant process, or in the form of a solution obtained by dispersion in an appropriate solvent or an emulsion obtained by a known emulsifying method, and provides antifoam composition having a good foam control effect.

In one specific embodiment herein, antifoam composition can be prepared in the form of an emulsion, and more specifically, an oil-in-water emulsion. In one embodiment with the use of emulsions, anti-foam composition as described herein, is easily dispersed in surfactant process(es) and accordingly, is more efficient and more effective in smaller quantities in treating surfactant process(es) and at a faster rate than is the case when such emulsions are not utilized.

In one specific embodiment herein, as emulsifiers, there can be utilized any emulsifier component (e) which is acceptable in a foamed system(s) to which antifoam composition is to be added. In a further specific embodiment, some non-limiting examples of emulsifier component (e) are compounds selected from conventional emulsifier component, such as, for example polyoxyethylene sorbitan monostearate, sorbitan monostearate, polyoxyethylene stearate, silicone polyethers such as the non-limiting example of Silwet DA-63®. In one other specific embodiment, for most food contact applications, it is preferred to utilize as emulsifier component (e) the non-limiting example of a mixture of sorbitan monostearate and polyoxyethylene stearate, commercially available from the Atlas Chemical Company. In one embodiment, as is well known, other traditional or desired ingredients can be added to antifoam composition, emulsifiable antifoam composition or emulsified antifoam composition described herein. In one specific embodiment some non-limiting examples are for example, sorbic acid, glutaraldehyde or an isothiazolone chemistry based biocide such as Kathon LXE®. In another embodiment any other conventional procedures of forming emulsion of antifoam composition utilizing at least one antifoam component or at least two antifoam components, as described herein, can be utilized to prepare emulsifiable antifoam composition or emulsified antifoam composition.

One specific embodiment for producing emulsified antifoam composition herein consists of adding emulsifier component (e) such as sorbitan monostearate and oxyethylene stearate to water and heating the resulting mixture to temperatures of from about 60 to about 100 degrees celsius under high shear agitation, and to this mixture there can be added a desired amount of antifoam composition consisting of at least one antifoam component or at least two antifoam components as described herein and prepared as discussed herein.

In a further specific embodiment, after antifoam composition has been added at a temperature of from about 60 to about 90 degrees celsius, mixing is continued for a period of time of anywhere from about 0.1 to about 2 hours until the mixture is uniform and then the heating bath is removed and additional water can be gradually added to dilute emulsified antifoam composition to a desired degree, which has been emulsified, while at the same time maintaining herein described high shear agitation; the mixture that results is then a stable emulsified antifoam composition and can be utilized with good dispersability. Optionally the emulsion can be homogenized with any type of homogenizer or colloid mill.

In another specific embodiment, a procedure for forming emulsified antifoam composition which was utilized in the examples below, and which is given as a non-limiting example comprises incorporating the herein described antifoam composition into a suitable laboratory vessel and adding thereto emulsifier component(s) (e) selected from the group consisting of polyoxyethylene stearylether; at least one silicone polyether copolymer surfactant; at least one alkylene glycol with a non-limiting example such as propylene glycol; cellulosic or polysaccharide thickening agent with a non-limiting example such as xanthum gum; water and emulsifier component (e); and combinations thereof; followed by mixing the contents of the laboratory vessel for a period of from about 2 to about 10 minutes with a rotational speed of specifically, of from about 800 to about 1200 rpm, at of from about 50 to about 80 degrees celsius; followed by mixing at ambient temperatures for a similar period and at a similar speed; followed by the addition of further suitable amounts of water during which emulsion converts from an oil continuous phase into a water continuous phase; followed by mixing at ambient temperatures for a similar period as described above; followed by addition of a suitable small amount of biocide based on isothiazolone chemistry; followed by ceasing of mixing. In one specific embodiment, irrespective of which process(es) is utilized, the process(es) should be adopted to fit the particular need(s) of the specific application(s). In a further specific embodiment, any conventional process for mixing can be utilized which produces a sufficiently stable emulsion in a short period of time. In one specific embodiment, a sufficiently stable emulsion can comprise an emulsion that does not show any separation or other forms of degradation for several months during storage at ambient temperature or for several days if stored at 50 degrees celsius.

In one specific embodiment, emulsified antifoam composition prepared herein has a shelf stability of 6 months to a year.

In another specific embodiment, there is provided emulsifiable composition comprising antifoam composition as described herein and at least one emulsifier component (e), where the emulsifier component (e) is at least one of the above-described emulsifier components.

In another specific embodiment herein, there is provided emulsified antifoam composition, which comprises emulsifiable antifoam composition as described above. In one embodiment, antifoam composition can be made in any known way and emulsified in any known way. In one specific embodiment, antifoam composition herein comprises reacting at least one antifoam component, or alternatively, antifoam composition can comprise at least two antifoam components, being first and second antifoam components as described herein, which are reacted separately; and further; emulsifying at least one antifoam component; and in the case of at least two antifoam components, mixing reacted first antifoam component and reacted second antifoam component and then emulsifying said mixed and reacted first and/or second antifoam components into emulsion. In another embodiment herein, reacted first antifoam component and reacted second antifoam component can be emulsified separately and then emulsified first antifoam component and emulsified second antifoam component can be blended together. In one specific embodiment, any process of forming emulsion from reacted antifoam component, or reacted first antifoam component and reacted second antifoam component, as described above, can then be used in a process of treating foam in surfactant processes and media, as are well known to those skilled in the art.

In one embodiment, antifoam effective amount of at least one antifoam component, and at least two antifoam components, being first antifoam component and second antifoam component, although generally described above, can be formulated into antifoam composition, emulsifiable antifoam composition or emulsified antifoam composition, in amounts that can be determined by user(s) of antifoam composition, emulsifiable antifoam composition or emulsified antifoam composition depending on the needs of the user(s) and/or the specifics of the surfactant process(es) to be treated, to which antifoam composition, emulsifiable antifoam composition or emulsified antifoam composition is applied.

In another specific embodiment herein, there is provided a process for treating a surfactant process, which comprises adding to a surfactant process a knockdown amount and/or durability amount of at least one antifoam composition. In one specific embodiment a knockdown amount and/or a durability amount can have the same definition as provided above for an antifoaming effective amount. In a more specific embodiment a knockdown amount and/or a durability amount can be specifically from about 1 to about 1000 ppm, more specifically from about 2 to about 100 ppm and most specifically from about 3 to about 20 ppm.

In yet another specific embodiment herein, there is provided a process for treating a surfactant process, which comprises adding to a surfactant process a knockdown amount and/or durability amount of at least one emulsifiable antifoam composition as described above.

In another specific embodiment herein, there is provided a process for treating a surfactant process which comprises adding to surfantant process a knockdown amount and/or durability amount of at least one emulsified antifoam composition.

In one specific embodiment, the modified shake test as described herein, can measure “knockdown” time and “durability” time. The phrases “knockdown time” and “durability time” can have the general definitions as provided above, and in one specific embodiment herein they will be determined using the modified shake test as is described in detail herein. In this shake test “knockdown time” is measured after a short period of shaking as described above and “durability time” is measured after a long period of shaking as described above.

Another, commonly used antifoam testing method is the “recirculation test.” In a recirculation test foamant is continuously circulated in a closed loop. An electrical pump sucks the foaming liquid through suitable tubing and exits via a nozzle attached to the end of the tube. The force of the turbulent liquor jet exiting the nozzle and striking the undisturbed liquid surface (and hence completing the closed loop), rapidly entrains air and creates a column of stable foam within a measuring cylinder or other graduated vessel. When the foam has reached a predetermined height or level on the cylinder an amount of the antifoam is dosed into the circulating liquid. The dosage of the antifoam at this point will normally result in a rapid collapse of the stable column of foam. In this recirculation test “knockdown level” is generally defined as the lowest level of the collapsed foam or sometimes as the time it takes to reach this level. “Durability level” in a recirculation test is defined as the amount of time in seconds that a foaming process that has been treated with antifoam composition will take to regenerate foam to the predetermined height at which it was treated. In a further specific embodiment, knockdown level and durability level have the same definition and specific values as described herein for a black liquor process.

In one embodiment antifoam composition herein can comprise at least one antifoam component as described herein. In one other embodiment, antifoam composition herein can be any mixture of first antifoam component and second antifoam component provided that some amount of first antifoam component and second antifoam component, as described herein, are present. In one specific embodiment herein, at least one antifoam component as described herein can have the properties of either knockdown or durability. In one specific embodiment herein, knockdown time and durability time are those values described below as measured by the modified shake test.

In one specific embodiment herein, first antifoam component can have properties of knockdown time as described below and second antifoam component can have properties of durability time as described below. In yet a further embodiment, amounts of first antifoam component and second antifoam component can be adjusted by end user(s) to have particular varying properties of both knockdown time and durability time as described below. In one specific embodiment, antifoam composition, emulsifiable antifoam composition or emulsified antifoam composition can have properties of knockdown time as described below by using substantially first antifoam component as described herein in antifoam composition. In another embodiment, antifoam composition, emulsifiable antifoam composition or emulsified antifoam composition can have the properties of durability time as described below by using substantially second antifoam component as described herein in antifoam composition. In one embodiment, it will be understood that antifoam composition can comprise any relative amounts of first antifoam component and second antifoam component provided that both first antifoam component and second antifoam component are present. In one specific embodiment, end user(s) of antifoam composition can use varying amounts of a knockdown antifoam composition with properties of knockdown time as described below and a durability antifoam composition with properties of durability time as described below. In another specific embodiment end user(s) of antifoam composition can use varying amounts of antifoam component having properties of knockdown time as described below and antifoam component having properties of durability time as described below to form either a substantially superior knockdown time antifoam composition or a substantially superior durability time antifoam composition, wherein knockdown time antifoam component and durability time antifoam component are used in the amounts described above for first antifoam component and second antifoam component. In yet a further embodiment, it will be understood that emulsifiable antifoam composition or emulsified antifoam composition can also have similar varying properties as described above and can likewise be used by end-user(s) to achieve desired knockdown time and/or durability time in treating surfactant process(es).

In one specific embodiment, surfactant processes can be any known or used industrial and/or commercial process where an undesirable amount of foam can be produced therein.

In one specific embodiment, there is provided a process for controlling foam formation in a black liquor pulping process, which comprises adding to the black liquor at least one antifoam composition, emulsifiable antifoam composition or emulsified antifoam composition as described herein.

In one specific embodiment herein, there is provided antifoam composition, emulsifiable antifoam composition, or emulsified antifoam composition that has higher potency than the conventional silicone antifoams used in the pulp and paper markets; that is antifoam composition, emulsifiable antifoam composition, or emulsified antifoam composition provided herein attains the same foam control at lower silicone use than conventional silicone antifoam compositions. In another specific embodiment, in addition to the obvious advantages of more efficient foam control on antifoam usage and hence cost to the customer, lower silicone is also advantageous on the quality of the pulp produced; the presence of silicone within paper pulp is a problem and can influence the selection and use of silicone antifoams; lower silicone levels used in a pulp mill will reduce the presence of silicone deposits within the paper pulp.

In one embodiment herein, knockdown level in a black liquor process can entail having foam reduction in an aqueous system as is described above for knockdown level. In another embodiment herein, durability level in a black liquor process can entail maintaining the level of foam in an aqueous system as is described above for durability level.

In another specific embodiment, there is provided a process of treating a surfactant process. In one embodiment, a surfactant process can comprise non-limiting examples selected from the group consisting of textile scouring process, textile dyeing process, carpet scouring process, carpet dyeing process, bottle washing process, metalworking fluids process, cleaning fluids process, agricultural adjuvants process, detergent process, such as the non-limiting examples of laundry, industrial, liquid and solid detergents, paper-making process, pulping process, paint-making process, coating process, textile-making process, metal-working process, adhesive-making process, polymer manufacturing process, agricultural process, oil-well cement-making process, cleaning compound-making process, cooling tower operation process, chemical process, municipal and/or industrial waste water treatment process, pharmaceutical-making process, food-making process, vegetable washing process, petroleum-treatment process, oil and gas mining process, gas sweetening process, carpet manufacturing and/or treating process, and combinations thereof.

In one embodiment, although knockdown time and/or durability time can vary as described above, the amount of antifoam composition added to surfactant process provides a foam knockdown time of specifically, shorter than 10 seconds, more specifically shorter than 8 seconds and most specifically shorter than about 6 seconds and, durability time of specifically, shorter than about 25, more specifically shorter than about 20 seconds and most specifically shorter than about 15 seconds. In one embodiment a superior knockdown time is specifically shorter than about 6 seconds and a superior durability time is shorter than about 15 seconds. In a further specific embodiment at least one antifoam component can have the above-described values of knockdown time. In another specific embodiment at least one antifoam component can have the above-described values of durability time. In yet a further specific embodiment, at least one first antifoam component, as described herein, can have the above-described values of knockdown time. In yet still a further specific embodiment, at least one second antifoam component, as described herein can have the above-described values of knockdown time. In yet still even a further specific embodiment, at least one antifoam composition comprising at least one antifoam component as described herein or first and second antifoam component as described herein can have the above described values of knockdown time and/or durability time. In yet another specific embodiment at least one antifoam emulsion comprising antifoam composition can have the above-described values of knockdown and/or durability time.

The examples below are given for the purpose of illustrating the invention of the instant case. They are not being given for any purpose of setting limitations on the embodiments described herein. All parts are by weight.

### EXAMPLES

Laboratory preparation of the described silicone antifoam composition comprising at least one antifoam component as described herein is conducted in a suitable laboratory vessel that is removed of any contaminants and can withstand temperatures around 200 degrees celsius, for example, stainless steel or Pyrex glass

All weight percents described in the below abbreviations for silicone fluid (a), silicone resin (b) and catalyst (d) are weight percents based upon the total weight of silicone fluid (a), silicone fluid (b) and catalyst (d) respectively. Abbreviation of materials used in the examples:

At least one silicone fluid (a):

Silicone Fluid-1: A blend of 18 weight percent of a trimethylsiloxy-end-capped polydimethylsiloxane gum (with about 400,000 Dalton molecular weight and 82 weight percent of a trimethylsiloxy-end-capped polydimethylsiloxane fluid with viscosity of 350 centistokes; the viscosity of the blend was 60,000 centistokes

Silicone Fluid-2: trimethylsiloxy-end-capped polydimethylsiloxane with viscosity of 60,000 centistokes

Silicone Fluid-3: Aminosilicone fluid with the formula MD₅₀₀D*₃M, as described above for formula MDₓD*_{y}M and a viscosity of 4,000 centistokes

Silicone Fluid-4: trimethylsiloxy-end-capped polydimethylsiloxane with viscosity of 30,000 centistokes

Silicone Fluid-5: trimethylsiloxy-end-capped polydimethylsiloxane with viscosity of 300,000 centistokes

Silicone Fluid-6: trimethylsiloxy-end-capped polydimethylsiloxane with viscosity of 350 centistokes

At least one silicone resin (b):

Resin-1: 60 weight percent of an M_{0.70}Q silicone resin in toluene with a viscosity of from 11.6 to 13.0 centistokes.

Resin-2: M_{0.6}Q in Aromatic-100 solvent (made by Exxon) with about 45 to about 60 weight percent solids; in all batches as much of Resin-2 was added that gave 10 weight percent of M_{0.6}Q in the final antifoam composition.

Resin-3: M_{0.6}Q resin in ethanol, with about 35 to about 40 weight percent solids; as much of Resin-3 was added that gave 10 weight percent M_{0.6}Q in the final antifoam composition.

Resin-4: 60 weight percent of an M_{0.70}Q silicone resin in toluene with a viscosity of from 9.0 to 11.5 centistokes.

At least one inorganic particulate (c):

Silica-1: Exp 100001-2, partially hydrophobized, precipitated silica, obtained from Degussa Corporation.

Silica-2: Aerosil R-974®, hydrophobized, fumed silica, made by Degussa Corporation

Silica-3: Aerosil R-812 S®, hydrophobized, fumed silica, made by Degussa Corporation

Silica-4: Aerosil 300®, fumed silica (non-hydrophobized), made by Degussa Corporation

Silica-5: Aerosil R-812®, hydrophobized, fumed silica, made by Degussa Corporation

Silica-6: Sipemat D-10®, hydrophobized, precipitated silica, made by Degussa

Corporation

Catalyst (d):

Catalyst-1: 50 weight percent of KOH in water

Catalyst-2: 10 weight percent of KOH in 2-propanol.

Catalyst-3: Potassium-silanolate.

Catalyst-4: KOH powder.

Preparation of High Knockdown Antifoam Components and emulsions

In the following Examples AI-AXVI components and their emulsions were prepared, which yielded antifoam compositions with superior properties of knockdown.

### Example AI

Preparation of Antifoam Component

The following one-pot procedure was used to prepare 300 grams of antifoam component. Accurately weighed 252 grams of Silicone Fluid-1, 51 grams of Resin-1 (in toluene), 9 grams of Silica-1 and 9 grams of Silica-2 powder, and 1.5 grams of Catalyst-1 into a suitable reactor with adequate capacity. The amount of MQ resin in the final component in this example was (at most) 10 weight percent based on the total weight of antifoam component (all amounts of MQ resin described below are based on the total weight of antifoam component). The reactor was placed in a suitable oil bath which had been preheated to 190 degrees celsius. A suitable mechanical laboratory agitator was fitted with a Cowles type (with saw-teeth) mixing blade, with a diameter of 3.175 centimeters (cm), into the filled reactor. The reactor was safely and securely sealed with a lid. A laboratory condenser and receiver were added securely to the lid of the reactor and cold water was flown through the water jacket surrounding the condenser. The rotational speed of the laboratory mechanical agitator in the filled reactor was slowly increased to approximately 200 rpm. The actual initial rotational speed of the agitator was deliberately low as to avoid any ‘blow-out’ of the fumed hydrophobic silica. Similarly, a low inert gas (nitrogen) was introduced as a purge into the reactor headspace. Once all the fumed hydrophobic silica has been incorporated into the liquid phase the rotational speed of the mixing blade was increased to approximately 600 rpm. The subsequent rise in temperature of the filled reactor contents above the atmospheric boiling point of the solvent resulted in the removal of the solvent and its subsequent capture of the solvent condensate. The rotational speed and oil bath temperature was maintained at 600 rpm and 190 degrees celsius respectively, for a further 6 hours. After this heat treatment time period has elapsed, the agitator was stopped and the reactor was removed from the hot oil bath. Once the reactor has cooled to ambient temperatures the condenser, receiver, lid and mechanical agitator were removed. The at least one silicone antifoam component could be used in silicone antifoam composition described herein or resultant at least one silicone antifoam component could itself be used as silicone antifoam composition; either of which was formed was then be transferred into a dry and clean laboratory storage vessel for further evaluation.

Preparation of Antifoam Emulsion

The antifoam component made with the above procedure was emulsified using the following procedure.

Using a clean and suitable laboratory vessel such as described above, the vessel with suitable support was placed into a water bath preheated to 60 degrees celsius. A Cowles blade mixer with a 3.175 cm diameter was attached and inserted into the lab reactor, as described above. Ten grams of the aforementioned prepared silicone antifoam component was accurately weighed into the vessel. 0.65 grams of a polyoxyethylene (21) stearyl ether and 1.35 grams of a polyoxyethylene (2) stearyl ether were accurately weighed into the reactor. Then 2.6 grams of a silicone polyether copolymer surfactant with an ethylene oxide and propylene oxide weight ratio of 1:4, uncapped, more specifically Silwet DA-63® made by GE Advanced Materials, was accurately weighed into the reactor. Four grams of propylene glycol was accurately weighed into the reactor. After this 0.05 grams of a cellulosic, or polysaccharide thickening agent, more specifically xanthan gum was accurately weighed into the reactor. Four grams of water was added into the reactor. The resultant blend was mixed with the mechanical laboratory mixer for a 5-minute period with a rotational speed of 1000 rpm. After this time period has elapsed, the laboratory agitator was stopped and the reactor was removed from the water bath. The resultant blend was mixed with the mechanical laboratory agitator for a further 5 minutes at 1000 rpm and then 77.35 grams of water was slowly added. During this step the fabricated emulsion inverted from an oil continuous phase into a water continuous phase. The resultant emulsion was mixed at 1000 rpm for a further 5-minute period. The mechanical laboratory mixer was stopped and removed from the reactor and the contents of the lab reactor were transferred into a clean and suitable laboratory storage vessel for future evaluations. A small amount, typically 0.001 weight percent of biocide based upon isothiazolone chemistry, such as Kathon LXE made by Rohm and Haas, was also added to protect the prepared silicone antifoam emulsion from bacterial attack.

### Example AII

Preparation of Antifoam Component

A similar procedure was used as in Example AI, except that 73.2 grams of Resin-2 was added instead of Resin-1 and as inorganic particulate (c) 9 grams of Silica-6 and 9 g of Silica-2 were used. The final MQ-resin content of the antifoam component was 10 weight percent.

Preparation of Antifoam Emulsion

The above antifoam component was emulsified using the same method as in Example AI.

### Example AIII

Preparation of Antifoam Component

A similar procedure was used as in Example AI, except that 244.5 grams of Silicone Fluid-2 was used instead of Silicone Fluid-1; 73.2 grams of Resin-2 was added instead of Resin-1; as inorganic particulate (c) 9 grams of Silica-3 and 9 grams of Silica-2 were added and as catalyst (d) 7.5 grams of Catalyst-2 were added. The final MQ-resin content of the antifoam component was 10 weight percent.

Preparation of Antifoam Emulsion

The above antifoam component was emulsified using the same method as in Example AI.

### Example AIV

Preparation of Antifoam Component

A similar procedure was used as in Example AI, except that 250.5 grams of Silicone Fluid-2 was used instead of Silicone Fluid-1; and as inorganic particulate (c) 9 grams of Silica-4 and 9 grams of Silica-5 were used. The final MQ-resin content of the antifoam component was 10 weight percent.

Preparation of Antifoam Emulsion

The above antifoam component was emulsified using the same method as in Example AI.Example AV

Preparation of Antifoam Component

A similar procedure was used as in Example AI, except that 239.4 grams of Silicone Fluid-2 was used instead of Silicone Fluid-1; as silicone resin 120 grams of Resin-3 was used; and as catalyst (d) 12.6 grams of Catalyst-3 was used. The final MQ-resin content of the antifoam component was 10 weight percent.

Preparation of Antifoam Emulsion

The above antifoam component was emulsified using the same method as in Example AI.

### Example AVI

Preparation of Antifoam Component

A similar procedure was used as in Example AI, except that 244.5 grams of Silicone Fluid-3 was used instead of Silicone Fluid-1; as silicone resin, 51 grams of Resin-4 was used, as inorganic particulate (c) 9 grams of Silica-4 and 9 grams of Silica-6 was used; and as catalyst (d) 7.5 grams of Catalyst-2 was used. The final MQ-resin content of the antifoam component was 10 weight percent.

Preparation of Antifoam Emulsion

The above antifoam component was emulsified using the same method as in Example AI.

### Example AVII

Preparation of antifoam component

A similar procedure was used as in Example AI, except that 251.25 grams of Silicone Fluid-3 was used instead of Silicone Fluid-1; as inorganic particulate (c) 9 grams of Silica-3 and 9 grams of Silica-1 were used; as catalyst (d) 0.75 grams of Catalyst-4 was used. The final MQ-resin content of the antifoam component was 10 weight percent.

Preparation of Antifoam Emulsion

The above antifoam component was emulsified using the same method as in Example AI.

### Example AVIII

Preparation of Antifoam Component

A similar procedure was used as in Example AI, except that 252 grams of Silicone Fluid-2 was used instead of Silicone Fluid-1; as silicone resin, 73.2 grams of Resin-2 was used, as inorganic particulate (c) 18 grams of Silica-5 was used and the heat treatment time was 22 hours, instead of 6 hours. The final MQ-resin content of the antifoam component was 10 weight percent.

Preparation of Antifoam Emulsion

The above antifoam component was emulsified using the same method as in Example AI.

### Example AIX

Preparation of Antifoam Component

A similar procedure was used as in Example AI, except that 250.5 grams of Silicone Fluid-2 was used instead of Silicone Fluid-1; as inorganic particulate (c) 18 grams of Silica-5 and as catalyst (d) 7.5 grams of Catalyst-2 were used. The final MQ-resin content of the antifoam component was 10 weight percent.

Preparation of Antifoam Emulsion

The above antifoam component was emulsified using the same method as in Example AI.

### Example AX

Preparation of Antifoam Component

A similar procedure was used as in Example AI, except that 250.5 grams of Silicone Fluid-2 was used instead of Silicone Fluid-1; as inorganic particulate (c) 18 grams of Silica-5 was used and as catalyst (d) 0.25 grams of Catalyst-4 was used. The final MQ-resin content of the antifoam component was 10 weight percent.

Preparation of Antifoam Emulsion

The above antifoam component was emulsified using the same method as in Example AI.

### Example AXI

Preparation of Antifoam Component

A similar procedure was used as in Example AI, except that 250.5 grams of Silicone Fluid-2 was used instead of Silicone Fluid-1; and as inorganic particulate (c) 18 grams of Silica-5 was used. The final MQ-resin content of the antifoam component was 10 weight percent.

Preparation of Antifoam Emulsion

The above antifoam component was emulsified using the same method as in Example AI.

### Example AXII

Preparation of Antifoam Component

A similar procedure was used as in Example AI, except that 250.5 grams of Silicone Fluid-2 was used instead of Silicone Fluid-1; as silicone resin 73.2 grams of Resin-2 was used and as inorganic particulate (c) 18 grams of Silica-5 was used. The final MQ-resin content of the antifoam component was 10 weight percent.

Preparation of Antifoam Emulsion

The above antifoam component was emulsified using the same method as in Example AI.

### Example AXIII

Preparation of Antifoam Component

A similar procedure was used as in Example AI, except that 250.5 grams of Silicone Fluid-2 was used instead of Silicone Fluid-1; and as inorganic particulate (c) 18 grams of Silica-5 was used. The final MQ-resin content of the antifoam component was 10 weight percent.

Preparation of Antifoam Emulsion

The above antifoam component was emulsified using the same method as in Example AI.

### Example AXIV

Preparation of Antifoam Component

A similar procedure was used as in Example AI, except that 250.5 grams of Silicone Fluid-4 was used instead of Silicone Fluid-1; as silicone resin, 83.4 grams of Resin-3 was used and as inorganic particulate (c) 18 grams of Silica-5 was used, and the heat treatment time was 22 hours, instead of 6 hours. The final MQ-resin content of the antifoam component was 10 weight percent.

Preparation of Antifoam Emulsion

The above antifoam component was emulsified using the same method as in Example AI.

### Example AXV

Preparation of Antifoam Component

A similar procedure was used as in Example AI, except that 250.5 grams of Silicone Fluid-2 was used instead of Silicone Fluid-1; as inorganic particulate (c) 9 grams of Silica-2 and 9 grams of Silica-6 were used, and the heat treatment time was 22 hours, instead of 6 hours. The final MQ-resin content of the antifoam component was 10 weight percent.

Preparation of Antifoam Emulsion

The above antifoam component was emulsified using the same method as in Example AI.

### Example AXVI

Preparation of Antifoam Component

A similar procedure was used as in Example AI, except that 250.5 grams of Silicone Fluid-2 was used instead of Silicone Fluid-1; as silicone resin, 73.2 grams of Resin-2 was used, as inorganic particulate (c) 18 grams of Silica-5 was used, and the heat treatment time was 22 hours, instead of 6 hours. The final MQ-resin content of the antifoam component was 10 weight percent.

Preparation of Antifoam Emulsion

The above antifoam component was emulsified using the same method as in Example AI.

Preparation of High Durability Antifoam Components and Emulsions

In the following Examples BI-BIX antifoam components and their emulsions were prepared which yielded antifoam compositions with improved durability time.

### Example BI

Preparation of Antifoam Component

A similar procedure was used as in Example AI, except that 250.5 grams of Silicone Fluid-5 was used instead of Silicone Fluid-1; as silicone resin 57 grams of Resin-2 and as inorganic particulate (c) 18 grams of Silica-5 was used, and the heat treatment time was 2 hours, instead of 6 hours. The final MQ-resin content of the antifoam component was 10 weight percent.

Preparation of Antifoam Emulsion

The above antifoam component was emulsified using the same method as in Example AI.

### Example BII

Preparation of Antifoam Component

A similar procedure was used as in Example AI, except that 250.5 grams of Silicone Fluid-5 was used instead of Silicone Fluid-1; as silicone resin 57 grams of Resin-2 and as inorganic particulate (c) 18 grams of Silica-5 was used. The final MQ-resin content of the antifoam component was 10 weight percent.

Preparation of Antifoam Emulsion

The above antifoam component was emulsified using the same method as in Example AI.

### Example BIII

Preparation of Antifoam Component

A similar procedure was used as in Example AI, except that 250.5 grams of Silicone Fluid-5 was used instead of Silicone Fluid-1; as silicone resin 57 grams of Resin-2 was used and as inorganic particulate (c) 18 grams of Silica-5 was used, and the heat treatment time was 22 hours, instead of 6 hours. The final MQ-resin content of the antifoam component was 10 weight percent.

Preparation of Antifoam Emulsion

The above antifoam component was emulsified using the same method as in Example AI.

### Example BIV

Preparation of Antifoam Component

A similar procedure was used as in Example AI, except that 267 grams of Silicone Fluid-5 was used instead of Silicone Fluid-1; as silicone resin 42.74 grams of Resin-2 was used and as inorganic particulate (c) 9 grams of Silica-2 was used. The final MQ-resin content of the antifoam component was 7.5 weight percent.

Preparation of Antifoam Emulsion

The above antifoam component was emulsified using the same method as in Example AI.

### Example BV

Preparation of Antifoam Component

A similar procedure was used as in Example AI, except that 264 grams of Silicone Fluid-5 was used instead of Silicone Fluid-1; as silicone resin 57 grams of Resin-2 and as inorganic particulate (c) 3 grams of Silica-2 was used. The final MQ-resin content of the antifoam component was 10 weight percent.

Preparation of Antifoam Emulsion

The above antifoam component was emulsified using the same method as in Example AI.

### Example BVI

Preparation of Antifoam Component

A similar procedure was used as in Example AI, except that 266 grams of Silicone Fluid-5 was used instead of Silicone Fluid-1; as silicone resin 57 grams of Resin-2 and as inorganic particulate (c) 2.25 grams Silica-2 were used. The final MQ-resin content of the antifoam component was 10 weight percent.

Preparation of Antifoam Emulsion

The above antifoam component was emulsified using the same method as in Example AI.

### Example BVII

Preparation of Antifoam Component

A similar procedure was used as in Example AI, except that 250.5 grams of Silicone Fluid-5 was used instead of Silicone Fluid-1; as silicone resin 57 grams of Resin-2 and as inorganic particulate (c) 18 grams of Silica-2 were used. The final MQ-resin content of the antifoam component was 10 weight percent.

Preparation of Antifoam Emulsion

The above antifoam component was emulsified using the same method as in Example AI.

### Example BVIII

Preparation of Antifoam Component

A similar procedure was used as in Example AI, except that 267 grams of Silicone Fluid-5 was used instead of Silicone Fluid-1; as silicone resin 57 grams of Resin-2 was used and as inorganic particulate (c) 1.5 grams of Silica-2 was used. The final MQ-resin content of the antifoam component was 10 weight percent.

Preparation of Antifoam Emulsion

The above antifoam component was emulsified using the same method as in Example AI.

### Example BIX

Preparation of Antifoam Component

A similar procedure was used as in Example AI, except that 244.5 grams of Silicone Fluid-5 was used instead of Silicone Fluid-1; as silicone resin 73.2 grams Resin-2 was used; as inorganic particulate (c) 9 grams of Silica-6 and 9 grams of Silica-2 was used, as catalyst (d) 7.5 grams of Catalyst-2 was used. The final MQ-resin content of the antifoam component was 10 weight percent.

Preparation of Antifoam Emulsion

The above antifoam component was emulsified using the same method as in Example AI.

Examples CI, CII and CIII have the following variations to show the further improvement found in using the above-described silicone fluid (a) viscosity, the presence of inorganic particulate (c) and the presence of at least filmed silica as inorganic particulate (c). Example CI: the silicone fluid (a) viscosity is only 350 centistokes. Example CII: there is no silica present at all. Example CIII: it has two precipitated silicas only and no fumed silica.

### Example CI

Preparation of Antifoam Component

The following two-pot procedure was used to make the antifoam component in 300 gram scale. First 239.4 grams of Silicone Fluid-6 and 73.2 grams of Resin-2 were accurately weighed into a suitable clean reactor with adequate capacity. The amount of silicone resin added to the reactor was such that the weight percentage of the solid resin in resultant at least one silicone antifoam component or, alternatively, silicone antifoam composition comprising at least one silicone antifoam component described herein, was 10 weight percent based on the total weight of at least one antifoam component. The reactor was placed in a suitable oil bath preheated to 190 degrees celsius. A Cowles type mechanical laboratory agitator fitted with a suitable mixing blade was fixed into the filled reactor. The reactor was safely and securely sealed with a suitable sealed lid. A suitable laboratory condenser and receiver were fitted securely to the lid of the reactor and cold water was flown through the water jacket surrounding the condenser. The subsequent rise in temperature of the filled reactor contents above the atmospheric boiling point of the solvent resulted in the removal of the solvent and its subsequent capture of the solvent condensate. The rotational speed and oil bath temperature were maintained at 600 rpm and 190 degrees celsius respectively for 6 hours. After this time period has elapsed, the agitator was stopped and the reactor was removed from the hot oil bath and the reactor and reactor contents were allowed to cool to ambient temperatures overnight.

Once the reactor has cooled to ambient temperatures the condenser, receiver, lid and mechanical agitator were removed. To the resultant reactor contents of resin and silicone oil fluid remaining in the reactor, 9 grams of Silica-4, 9 grams of Silica-2 and 12.6 grams of Catalyst-3 were accurately weighed. The reactor was placed in a suitable oil bath, which had been preheated to 190 degrees celsius. A mechanical laboratory agitator fitted with a Cowles type blade was fixed into the reactor containing the filled contents. The rotational speed of the mechanical laboratory agitator in the filled reactor was slowly increased to approximately 200 rpm. The actual initial rotational speed of the agitator was deliberately low as to avoid any ‘blow-out’ of the fumed hydrophobic silica. Once all the fumed hydrophobic silica had been incorporated into the liquid phase the rotational speed of the mixing blade was increased to approximately 600 rpm. The rotational speed and oil bath temperature were maintained at 600 rpm and 190 degrees celsius respectively for a further 6 hours. After this time period has elapsed, the agitator was stopped and the reactor was removed from the hot oil bath and it was allowed to cool to ambient temperature. The antifoam component (or if the antifoam component is the antifoam composition then the antifoam composition) formed was then transferred into a dry and clean laboratory storage vessel for further evaluation.

Preparation of Antifoam Emulsion

The above antifoam component (composition) was emulsified using the same method as in Example AI.

### Example CII

Preparation of Antifoam Component

A similar one-pot procedure was used as in Example AI, except that 268.5 grams of Silicone Fluid-5 was used instead of Silicone Fluid-1; as silicone resin 57 grams of Resin-2 and no silica inorganic particulate (c) was used. The final MQ-resin content of the antifoam component was 10 weight percent.

Preparation of Antifoam Emulsion

The above antifoam component was emulsified using the same method as in Example AI.

### Example CIII

Preparation of Antifoam Component

A similar two-pot procedure was used as in Example CI, except that 251.25 grams of Silicone Fluid-2 was used instead of Silicone Fluid-6, and as inorganic particulate (c) only precipitated silicas of 9 grams of Silica-1 and 9 grams of Silica-6 were used, and as catalyst (d) 0.75 grams of Catalyst-4 was added. The final MQ-resin content of the antifoam component was 10 weight percent.

Preparation of Antifoam Emulsion

The above antifoam component was emulsified using the same method as in Example AI.

### Example DI

In these examples antifoam component prepared in Example AX and Example BVI were first blended in various ratios and then the blends were emulsified using the same method as in Example AI. Table 1 shows the composition of the blends.

TABLE 1
Blending ratios in Examples D I-D V:

| | % compound from | % compound from |
|---|---|---|
| Example | Example A X | Example B VI |
| D I | 90 | 10 |
| D II | 70 | 30 |
| D III | 50 | 50 |
| D IV | 30 | 70 |
| D V | 10 | 90 |

Testing of Antifoaming Efficiency with Recirculation Test, Used for Black Liquor

Testing Procedure Using the Recirculation Test

Foam control evaluation is conducted by means of either knockdown and/or durability silicone antifoam composition, specifically in an emulsion (oil in water) form, in a closed recirculation loop of black liquor from a pulp mill (at temperatures between 75 and 80 degrees celsius). An electrical pump sucks the black liquor through suitable tubing and exits via a nozzle attached to the end of the tube. The force of the turbulent liquor jet exiting the nozzle and striking the undisturbed liquid surface of the black liquor, (and hence completing the closed loop), rapidly entrains air and creates a column of stable foam within a measuring cylinder or other graduated vessel. When the foam has reached a predetermined height or level on the cylinder (as determined by the individual user) an amount of the silicone antifoam is dosed, either by manual or automatic injection, into the circulating black liquor. The amount of silicone antifoam dosed at this point is related to the source and type of black liquor, the flow rate of the liquor passing through the circulating pump but also to the quantity and chemistry of silicone antifoam. Typically, the dosage is approximately between 10 to 200 ppm of product, for example, as emulsion or 100 percent antifoam composition fluid. The dosage of silicone antifoam composition comprising at least one antifoam component, or silicone antifoam composition comprising first and second antifoam components, at this point will normally result in an almost instantaneous collapse of the stable column (or head) of foam. This phenomenon of foam collapse, or defoaming, is commonly known to those within the pulp service industry and foam control science as “foam knockdown” or “initial foam knockdown” or “knockdown.” The lowest measured level achieved by the dosed antifoam is referred to as the “lowest foam level” or “foam knockdown level.” The time at which this lowest foam level is reached can also be recorded. Subsequently, after the foam has reached the lowest level achieved by the dosed amount of silicone antifoam composition comprising at least one antifoam component, or silicone antifoam composition comprising first and second antifoam components, the foam will begin to rise above this level. The rate at which the foam will rise is related to the chemistry and quantity of the silicone antifoam composition comprising at least one antifoam component, or silicone antifoam composition comprising first and second antifoam components dosed into the loop. The total time taken for the foam to regenerate back to its original foam height, or other predetermined level decided by the user, after the initial dosage of antifoam is referred to as “durability level” or “persistence” or “durability” of the dosed silicone antifoam composition comprising at least one antifoam component or silicone antifoam composition comprising first and second antifoam components.

As described above, pulp service companies commonly use a mobile experimental set up very similar to the one described herein.

Test results with antifoaming emulsions from one antifoam compound Table 2 shows the measured knockdown level and durability level values of emulsions prepared from the knockdown components in example AI-AX, emulsions from the examples CI-CIII and emulsions of the durability antifoams components BI-BIII and BVII, at various ppm addition levels as measured using the recirculation test. Also included are several competitive silicone foam control agents (I to VI) used widely in the pulping industry.

TABLE 2

| | Antifoam | “Knockdown” | “Durability”/ |
|---|---|---|---|
| | Actives | Lowest Foam Level | (secs) (to reach |
| Product/Example | dosed/(ppm) | (from 450 mL) | 450 ml) |
| No foam control | 0 | 450 | 0 |
| agent | | | |
| Competitive I | 8 | 305 | 109 |
| Competitive II | 8 | 470 | 62 |
| Competitive III | 12 | 410 | 62 |
| Competitive IV | 8 | 469 | 62 |
| Competitive V | 8 | 318 | 160 |
| Competitive VI | 8 | 272 | 91 |
| AI | 8 | 195 | 117 |
| AII | 8 | 167 | 163 |
| AIII | 8 | 167 | 485 |
| AIV | 8 | 128 | 388 |
| AV | 8 | 186 | 148 |
| AVI | 8 | 188 | 272 |
| AVII | 8 | 143 | 817 |
| AVIII | 8 | 148 | 625 |
| AIX | 8 | 141 | 290 |
| AX | 8 | 147 | 243 |
| Example C I | 8 | 331 | 92 |
| Example C III | 8 | 240 | 126 |
| Example C II | 17 | 370 | 289 |
| BVII | 17 | 122 | 2370 |
| BI | 11 | 197 | 336 |
| BII | 11 | 159 | 1273 |
| BIII | 11 | 236 | 919 |

It can be seen that Examples AI-AX yielded antifoam emulsions with improved knockdown level (lower minimum foam levels) than the competitive antifoams or examples CI and CIII, dosed at the same (8 ppm-actives) levels. The table also illustrates the very long durability level of antifoams BI-BIII.

The experimental conditions of the recirculation test attempt to reflect those consistent of a working Nordic pulp mill; 750 mL of a Nordic softwood black liquor are added at 75 to 80 degrees celsius into a suitable cylinder with a flow rate between 2700 to 3000 ml/min. Under these conditions, a 450 ml volume of foam will be created in approximately 40 to 55 seconds in the absence of any foam control agent. The dosage of the antifoam composition (amount) is triggered automatically when the foam level in the column has reached a 450 ml level. The data acquisition system is able to follow the foam level with time. A knockdown level of 200 ml and below at this actives level is designated “superior.” Similarly, a durability greater than 200 seconds is also designated “superior.”

The competitive examples listed in Tables 1 and 2 are results from various silicone antifoam products available in the market. The silicone antifoam compound in these products is believed to be based upon silica filled dispersions in single and/or various viscosity silicone oil grades, with or without silicone resin

Testing with modified shake test, using surfactant solution

In several industries, such as in textile manufacturing, carpet manufacturing, laundry detergents etc., surfactants are used and they cause foaming problems. The efficiency of several of the antifoams made in the examples above was tested with a test, which is commonly used with surfactants foams and compared to commercially available antifoams.

Shake test procedure using “modified shake test”

A more detailed description of the modified shake test generally described above was used to measure the antifoaming efficiency of several of the antifoam emulsions in Examples AI-AXIV (knockdown antifoams) and Examples BI-BIX and their combinations. The more detailed description of the modified shake test is as follows:

The foaming solution was prepared by dissolving 1 g Triton X-100® in 99 g deionized water.

The test preparation included the following steps:

a./ Dissolve 1 gram Kelzan AR gum (from Kelco) in 99 grams of deionized water.

b./ Prepare the first dilution: blend 65 grams Kelzan AR solution above, 30 grams deionized water and 5 grams of 10 weight percent antifoam emulsion (based on the total weight of antifoam emulsion) as prepared in Examples AI-AXIV and BI-BIX, in a 250 ml beaker, using an impeller with 2″ diameter propeller at 600 rpm, for 2 minutes.

c./ Prepare the second dilution: blend 5 grams of first dilution above with 95 grams deionized water, in a 250 ml beaker, using an impeller with 2″ diameter propeller at 600 rpm, for 2 minutes.

d./ Prepare the third dilution: Add 100 grams 1% Triton X-100 solution into a 250-mL glass jar. Add dropwise 3 grams of second dilution above, adding this way 7.5 ppm antifoam actives.

Procedure:

The jar was capped and clamped in upright position on a wrist-action shaker. Employing a radius of 10 (plus or minus) 0.2 cm (measured from the center of bottle), the jar was shaken for 10 seconds through an arc of 10 degrees at a frequency of 300 (plus or minus) 30 strokes per minute. Then, the time of foam collapse time recorded. The foam collapse time was determined at the instant the first portion of foam-free liquid surface appeared, measured from the end of the shaking period. Then the solution was shaken again for 30 seconds and the collapse time was measured again. It was shaken again for 5 minutes, followed by taking a foam collapse time measurement and then it was shaken again for 30 minutes. The collapse time after the 10 second shake characterizes the knockdown time (initial effect), and the collapse time after the 30 minute shake represents the durability time (persistence) of the antifoam.

Table 4 shows the results of several sets of shake tests with various combinations of a knockdown antifoam emulsion (selected from Examples AI-AXIV) and a durability antifoam emulsion (as selected from Examples BI-BIX). The performance of several, competitive antifoams, which are commonly used against surfactant stabilized foams, are also shown for comparison. In all tests 7.5 ppm of actives of antifoam were present.

Table 4 provides the foam collapse times in shake tests with various combinations of knockdown antifoam components and durability antifoam components which are reacted separately and emulsified separately and the subsequently the separately reacted and separately emulsified antifoam components are then blended.

TABLE 4

| Knock- | | | | | | | |
|---|---|---|---|---|---|---|---|
| down | | | | | | | |
| anti- | | | | Foam collapse | | | |
| foam | | Durability | | time in seconds, | | | |
| Exam- | % in | antifoam | % in | after shaking for | | | |
| ple # | blend | Example # | blend | 10 sec | 30 sec | 5 min | 30 min |
| A XIII | 100 | B V | 0 | 2.6 | 3.98 | 18.09 | 36 |
| | 50 | | 50 | 4.36 | 5.28 | 6.21 | 9.53 |
| | 25 | | 75 | 5.14 | 5.69 | 5.15 | 9.14 |
| | 0 | | 100 | 10.51 | 9.27 | 9.6 | 10.43 |
| A XIV | 100 | B VII | 0 | 5.22 | 4.97 | 13.73 | 26.22 |
| | 90 | | 10 | 6.26 | 5.5 | 8.66 | >60 |
| | 75 | | 25 | 4.94 | 5.06 | 6.34 | 20 |
| | 50 | | 50 | 5.9 | 5.5 | 5.6 | 8.9 |
| | 25 | | 75 | 5.8 | 4.8 | 5 | 7.7 |
| | 10 | | 90 | 6.5 | 5.36 | 4.39 | 7.15 |
| | 0 | | 100 | 6.4 | 6.36 | 5 | 7.02 |
| A XV | 100 | B IX | 0 | 3.6 | 4.93 | 7.06 | 7.17 |
| | 90 | | 10 | 3.58 | 5.44 | 6.96 | 9.01 |
| | 75 | | 25 | 3.8 | 5.01 | 7.44 | 9.8 |
| | 50 | | 50 | 3.61 | 4.97 | 6.74 | 9.8 |
| | 25 | | 75 | 4.28 | 5.42 | 6.33 | 10.53 |
| | 10 | | 90 | 5.85 | 6.17 | 7.87 | 10.53 |
| | 0 | | 100 | 6.4 | 6.14 | 7.62 | 11.84 |

| | | | | |
|---|---|---|---|---|
| Competitive antifoams: | | | | |
| Competitive VII | 9 | 19 | 30 | 30 |
| Competitive VIII | >60 | >60 | 24.1 | 13.42 |
| Competitive IX | 10.65 | 13.49 | >60 | >60 |
| Competitive X | >60 | >60 | >60 | >60 |

Tables 5 shows the results of Examples DI-DV, which, were made by separately reacting the separate knockdown and durability antifoam components and then mixing the separately reacted knockdown and durability antifoam components followed by emulsification of separately reacted and mixed knockdown and durability antifoam components. The performance of emulsions comprising the individual antifoam components are also shown in the table.

Table 5 provides the foam collapse time in shake tests with Examples D I-D V and the individual antifoam components, Examples A X and B VI. In this table the individual antifoam components were first reacted and then mixed together, and then subsequently the reacted and mixed antifoam components were emulsified together.

TABLE 5

| | % A X compound | Foam collapse time in sec after shaking for | | | |
|---|---|---|---|---|---|
| Name | in blend | 10 sec | 30 sec | 5 min | 30 min |
| A X | 100 | 3.7 | 5.85 | 18.68 | 32.82 |
| D I | 90 | 3.9 | 4.88 | 13.8 | 23.92 |
| D II | 70 | 4.74 | 5.6 | 7.75 | 20.92 |
| D III | 50 | 4.67 | 5.13 | 4.26 | 10.45 |
| D IV | 30 | 4.67 | 4.43 | 3.54 | 8.15 |
| D V | 10 | 4.32 | 4.94 | 3.78 | 6.93 |
| B VI | 0 | 5.92 | 6.91 | 6.06 | 8.48 |

The results in Tables 4 and 5 show that in all combinations of antifoam components there is at least one ratio of knockdown and durability antifoam components which has a knockdown time (10 sec shake) of less than about 6 seconds and a durability time (30 min shake) of less than 15 seconds, while none of the competitive antifoams were able to accomplish this. It can be also seen that the knockdown and durability antifoam component combinations have a more even performance than the competitive antifoams, that is, the foam collapse time hardly changes with the shake time.

While the above description comprises many specifics, these specifics should not be construed as limitations, but merely as exemplifications of specific embodiments thereof. Those skilled in the art will envision many other embodiments within the scope and spirit of the description as defined by the claims appended hereto.

1. An antifoam composition comprising an antifoaming-effective amount of at least one antifoam component, where antifoam component comprises product of the reaction of
(a) at least one silicone fluid,
(b) at least one silicone resin selected from the group consisting of silicone resin (i) having a ratio of M to Q units of from about 0.6/1 to about 0.8/1 and a different silicone resin (ii) having a ratio of M to Q units of from about 0.55/1 to about 0.75/1, optionally,
(c) at least one inorganic particulate possessing reactive surface groups; and,
(d) catalyst for the reaction of (a) and/or (b) with (c).

2. The antifoam composition of claim 1 where silicone resin (i) has a ratio of M to Q units of from about 0.63/1 to about 0.73/1 and silicone resin (ii) has a ratio of M to Q units of from about 0.57/1 to about 0.70/1.

3. The antifoam composition of claim 1 where silicone resin (i) has a ratio of M to Q units of from about 0.65/1 to about 0.70/1 and silicone resin (ii) has a ratio of M to Q units of from about 0.60/1 to about 0.67/1.

4. The antifoam composition of claim 1 where silicone fluid is polyorganosiloxane having a viscosity of from about 1000 to about 10,000,000 centistokes

5. The antifoam composition of claim 1 where silicone fluid is polyorganosiloxane having a viscosity of from about 5000 to about 2,000,000 centistokes.

6. The antifoam composition of claim 1 where silicone fluid is polyorganosiloxane having a viscosity of from about 10,000 to about 1,000,000 centistokes.

7. The antifoam composition of claim 1 comprising a first antifoam component and a second antifoam component wherein first antifoam component comprises a first silicone fluid which is a first polyorganosiloxane having a viscosity of from about 1000 to about 100,000 centistokes, and silicone resin (i); and second antifoam component comprises a second silicone fluid which is a second polyorganosiloxane having a viscosity of from about 10,000 to about 10,000,000 centistokes, the viscosity of the second silicone fluid being greater than the viscosity of first silicone fluid, and silicone resin (ii).

8. The antifoam composition of claim 1 comprising a first antifoam component and a second antifoam component wherein first antifoam component comprises a first silicone fluid which is a first polyorganosiloxane having a viscosity of from about 5000 to about 90,000 centistokes, and silicone resin (i); and second antifoam component comprises a second silicone fluid which is a second polyorganosiloxane having a viscosity of from about 30,000 to about 2,000,000 centistokes, the viscosity of the second silicone fluid being greater than the viscosity of first silicone fluid, and silicone resin (ii).

9. The antifoam composition of claim 1 comprising a first antifoam component and a second antifoam component wherein first antifoam component comprises a first silicone fluid which is a first polyorganosiloxane having a viscosity of from about 10,000 to about 80,000 centistokes, and silicone resin (i); and second antifoam component comprises a second silicone fluid which is a second polyorganosiloxane having a viscosity of from about 60,000 to about 1,000,000 centistokes, the viscosity of the second silicone fluid being greater than the viscosity of first silicone fluid, and silicone resin (ii).

10. The antifoam composition of claim 1 where silicone fluid is polyorganosiloxane having the formula:
MₐD_{b}M*₂₋ₐ
where
D=R¹R²SiO_{2/2}
M=R³R⁴, R⁵SiO_{1/2}
M*=R^{α}R^{β}R^{γ}SiO_{1/2}
where R¹, R², R³, R⁴, R⁵, R^{β} and R^{γ} are independently monovalent hydrocarbon radicals having one to sixty carbon atoms; R^{α} is a hydrocarbon radical having from one to sixty carbon atoms and containing either at least one hydroxyl group or at least one alkoxy group; the stoichiometric subscripts a and b are either zero or positive; subject to the limitations: b is a number greater than 220, and a is a number of from 0 to about 2.

11. The antifoam composition of claim 1 where silicone fluid is an aminosilicone.

12. The antifoam composition of claim 11 where aminosilicone has the formula Mₐ DₓD*_{y}M*₂₋ₐ, where D=R¹R²SiO_{2/2}, M=R³R⁴, R⁵SiO_{1/2}, M*=R^{α}R^{β}R^{γ}SiO_{1/2} D*=R^{A}SiO_{2/2}(CH₂)₃NH(CH₂)₂NH₂; where x is from 0 to 1000, y is from 0.5 to 25, a is a number of from 0 to 2, and where R^{A} is a monovalent hydrocarbon radical having from 1 to about sixty carbon atoms.

13. The antifoam composition of claim 12 where R^{A} is methyl and/or phenyl.

14. The antifoam composition of claim 1 where silicone resin (i) and silicone resin (ii) are selected from the group consisting of
M_{c}M^{H}_{d}M^{vi}ₑM^{E}_{f}Q_{g}T^{OH}ₐₐ;
MₕM^{H}ᵢM^{vi}ⱼM^{E}ₖD_{L}D^{H}ₘD^{vi}ₙD^{E}ₒQₚT^{OH}ₐₐ;
T_{q}T^{H}ᵣT^{vi}_{S}T^{E}ₜD^{OH}_{cc} resin and combinations thereof
where
M=R⁶R⁷, R⁸SiO_{1/2};
M^{H}=R⁹R¹⁰HSiO_{1/2};
Mᵥᵢ=R¹¹R¹²R¹³SiO_{1/2};
M^{E}=R¹⁴R¹⁵R^{E}SiO_{1/2};
D=R¹⁶R¹⁷SiO_{2/2};
D^{H}=R¹⁸HSiO_{2/2};
D^{vi}=R¹⁹R²⁰SiO_{2/2};
D^{E}=R²¹R^{E}SiO_{2/2};
D^{OH}=R^{BB}R^{CC}SiO_{2/2}
T=R²²SiO_{3/2};
T^{H}=HSiO_{3/2};
T^{vi}=R²³SiO_{3/2};
T^{E}=R^{E}SiO_{3/2};
T^{OH}=R^{AA}SiO_{3/2}
Q=SiO_{4/2}; and,
where R^{AA} and R^{BB} are independently OH or OR^{DD}, where R^{DD} is a monovalent hydrocarbon radical containing from one to six carbon atoms, R^{CC} is independently R²², hydrogen, R²³ or R^{E}; further where R⁶, R⁷, R⁸, R¹⁶, R¹⁷, and R²² are independently monovalent hydrocarbon radicals containing from one to sixty carbon atoms; R⁹, R¹⁰ and R¹⁸ are independently monovalent hydrocarbon radicals containing from one to sixty carbon atoms or hydrogen; R¹¹ is an unsaturated monovalent hydrocarbon radical containing from 2 to 10 carbon atoms, and R¹² and R¹³ are independently monovalent hydrocarbon radicals containing from one to sixty carbon atoms; R¹⁹ is an unsaturated monovalent hydrocarbon radical containing from 2 to 10 carbon atoms, and R²⁰ is a monovalent hydrocarbon radical containing from one to sixty carbon atoms; R²³ is an unsaturated monovalent hydrocarbon radical containing from 2 to 10 carbon atoms; R¹⁴, R¹⁵ and R²¹ are independently monovalent hydrocarbon radicals having from one to sixty carbons or R^{E}; each R^{E} is independently a monovalent hydrocarbon radical containing one or more oxirane moieties having from one to sixty carbon atoms; the stoichiometric subscripts c, d, e, f, g, h, i, j, k, L, m, n, o, p, q, r, s, t, aa, bb, and cc are zero or positive subject to the following limitations: if M_{c}M^{H}_{d}M^{vi}ₑM^{E}_{f}Q_{g}T^{OH}ₐₐ resin is used c+d+e+f≧3, g+aa≧2; and c+d+e+f+g≧5; if MₕM^{H}ᵢM^{vi}ⱼM^{E}ₖD^{L}D^{H}ₘD^{vi}ₙD^{E}ₒQₚT^{OH}_{bb} resin is used h+i+j+k≧3, L+m+n+o≧1, p+bb≧2, and h+i+j+k+L+m+n+o+p≧6; and if T_{q}T^{H}ᵣT^{vi}ₛT^{E}ₜD^{OH}_{cc} resin is used q+r+s+t+cc≧2.

15. The antifoam composition of claim 14 where silicone resin (i) is M_{c}M^{H}_{d}M^{vi}ₑM^{E}_{f}Q_{g}T^{OH}ₐₐ resin, silicone resin (ii) is M_{c}M^{H}_{d}M^{vi}ₑM^{E}_{f}Q_{g}T^{OH}ₐₐ resin and silicone fluid (a) is polyorganosiloxane having a viscosity of from about 1000 to about 10,000,000 centistokes.

16. The antifoam composition of claim 14 where more than one silicone resin (i) and/or more than one different silicone resin (ii) can be used which are selected from the group consisting of M_{c}M^{H}_{d}M^{vi}ₑM^{E}_{f}Q_{g}T^{OH}ₐₐ, MₕM^{H}ᵢM^{vi}ⱼM^{E}ₖD_{L}D^{H}ₘD^{vi}ₙD^{E}ₒQₚT^{OH}_{bb} and T_{q}T^{H}ᵣT^{vi}ₛT^{E}ₜD^{OH}_{cc} and combinations thereof with the proviso that at least one silicone resin (i) has a (M+M^{H}+M^{vi}+M^{E}) to (Q+T^{OH}) ratio of about 0.6 to about 0.8 and at least one different silicone resin (ii) has a different(M+M^{H}+M^{vi}+M^{E}) to (Q+T^{OH}) ratio of from about 0.55 to about 0.75, with the further proviso that at least one silicone resin (i) and at least one different silicone resin (ii) each independently must contain at least one silicone resin of the above described general formulas M_{c}M^{H}_{d}M^{vi}ₑM^{E}_{f}Q_{g}T^{OH}ₐₐ, or MₕM^{H}ᵢM^{vi}ⱼM^{E}ₖD_{L}D^{H}ₘD^{vi}ₙD^{E}ₒQₚT^{OH}_{bb}.

17. The antifoam composition of claim 1 where inorganic particulate (c) possessing reactive surface groups comprises fumed silica and optionally another inorganic particulate (c) selected from the group consisting of precipitated silica, silica aerogel, silica gel, hydrophobic silica, hydrophilic silica, silica that has been treated with a silicone material, silica that has been treated with a silane material, silica that has been treated with a nitrogen-containing material, titania, alumina, quartz, a different fumed silica and combinations thereof.

18. An emulsifiable composition comprising the antifoam composition of claim 1 and at least one emulsifier component (e).

19. An emulsifiable composition comprising the antifoam composition of claim 4 and at least one emulsifier component (e).

20. The emulsified composition of claim 18.

21. The emulsified composition of claim 19.

22. The emulsified composition of claim 20 having a knockdown time of less than about 10 seconds.

23. The emulsified composition of claim 20 having a durability time of less than about 25 seconds.

24. The emulsified composition of claim 20 having a knockdown time of less than about 10 seconds and a durability time of less than about 25 seconds.

25. A process for treating a surfactant process which comprises adding to a surfactant process a knockdown amount and/or a durability amount of at least one antifoam composition of claim 1.

26. A process for treating a surfactant process which comprises adding to a surfactant process a knockdown amount and/or a durability amount of at least one emulsifiable antifoam composition of claim 18.

27. A process for treating a surfactant process which comprises adding to a surfactant process a knockdown amount and/or a durability amount of at least one emulsified antifoam composition of claim 20.

28. The process of claim 25 where a surfactant process is selected from the group consisting of textile scouring process textile dyeing process, carpet scouring process, carpet dyeing process, bottle washing process, metalworking fluids process, cleaning fluids process, agricultural adjuvants process, detergent process, paper-making process, pulping process, paint-making process, coating process, textile-making process, metal-working process, adhesive-making process, polymer manufacturing process, agricultural process, oil-well cement-making process, cleaning compound-making process, cooling tower operation process, chemical process, municipal and/or industrial waste water treatment process, pharmaceutical-making process, food-making process, vegetable washing process, petroleum-treatment process, oil and gas mining process, gas sweetening process, carpet manufacturing and/or treating process, and combinations thereof.
